(19) United States
(12) Patent Application Publication
(10) Pub. No.: US 2021/0360746 A1
(43) Pub. Date: Nov. 18, 2021

(54) COMPOSITE SUBSTRATE, METAL-COATED COMPOSITE SUBSTRATE, AND METHODS OF PRODUCTION THEREOF

(71) Applicant: VALORBEC, SOCIETE EN COMMANDITE, Montreal (CA)

(72) Inventors: Mehdi HOJJATI, Dollard-des-Ormeaux (CA); Alireza RAHIMI, Richmond Hill (CA); Christian MOREAU, Boucherville (CA); Ali DOLATABADI, Montreal (CA)

(21) Appl. No.: 17/302,879

(22) Filed: May 14, 2021

Related U.S. Application Data
(60) Provisional application No. 63/025,925, filed on May 15, 2020.

(51) Int. Cl. H05B 3/16; H05B 3/26; B32B 15/02; B32B 15/14; B32B 15/18; C23C 4/02; C23C 4/06; C23C 4/129

(52) U.S. Cl. CPC H05B 3/16; H05B 3/267; B32B 15/02; B32B 15/14; B64D 15/12; C23C 4/02; C23C 4/06; C23C 4/129; B32B 15/18

(57) ABSTRACT

A composite substrate comprising a mesh layer and a composite material layer is provided, wherein the mesh layer comprises a mesh material and an adhesive, said adhesive permeating the mesh material and adhering the mesh material directly to a surface of the composite material layer. A metal-coated composite substrate is provided. The metal-coated composite substrate comprises a composite substrate, as defined in the section above, and a metal layer covering a side of the mesh layer opposite the composite layer. Furthermore, a method for producing the composite substrate is provided. Moreover, a method for producing the metal-coated composite substrate is provided.

### FIELD OF THE INVENTION

The present invention relates to a composite substrate. More specifically, the present invention is concerned with a composite substrate comprising a mesh layer and a composite material layer, wherein said composite substrate can be coated in metal and then used as an electro-thermal heating element for de-icing and anti-icing applications.

### BACKGROUND OF THE INVENTION

In the last decades, the application of composites in different industries, especially the aerospace industry, has been increased significantly due to their specific characteristics, such as a high strength to weight ratio. As polymeric composite materials comprise a high percentage of the structure of modern aircrafts and wind turbines, designing an appropriate de-icing and anti-icing system for such composite structures has a high level of importance. Different methods have been used for de-icing purposes in the aerospace industry, including the following: 1) bleed air de-icing systems, 2) electro-mechanical de-icing systems, 3) electro-thermal de-icing systems, 4) pneumatic boot systems, and 5) weeping wings.

Electro-thermal de-icing systems use electrical resistance heaters in different forms, for example wire, film, or foil for heating and de-icing the components of an airplane or wind-turbine. The electro-thermal heaters start heating the components as soon as an electrical current is applied to them. Electro-thermal de-icers generally have high efficiency as the generated heat in these systems flows directly into the accumulated ice. It also has been reported that using such de-icing systems extracts about 35% less power from the aircraft engines compared to conventional pneumatic systems. In addition, this type of de-icing system typically does not add considerable weight to the airplane, while in bleed air de-icing systems, ducting which is used for passing the pressurized air around the airplane adds hundreds of pounds of weight to the aircraft.

An electro-thermal heating element for composite structures are typically fabricated by addition, or, in other words, the deposition of a thin metallic coating layer on top of the composite structure using thermal spray techniques. Thermal spray techniques are a group of techniques and processes used for the deposition of a metallic or non-metallic coating onto a substrate. Based on the source of energy used for heating up and melting the coating materials (in the form of powder, wire, rod, ceramic, or molten materials), thermal spray processes can be divided into three categories, in which heating and energy is provided by: (1) combustion, (2) dissipation of electrical energy, or (3) high-pressure gases (in the case of cold spray). Once the coating materials are heated up, they are accelerated toward a substrate using process gases and form a bond with the surface. The subsequent particles will bond with the already deposited particles and form a lamellar structure.

Thermal spray processes are widely used for enhancing thermal, physical, mechanical, and tribological properties of metallic substrates. However, the coating of composite materials using thermal spray methods are associated with some serious challenges. First of all, polymeric materials have relatively low service temperatures (usually less than 300° C.), while in a thermal process, like plasma spraying, the substrate temperature might easily exceed 400° C. Furthermore, most of the treatment methods used for preparing and roughening the metallic substrates prior to the coating deposition process cannot be applied directly and without any surface modification to composites. For example, using grit blasting, in which substrates are roughened by the impact of high-velocity abrasive particles, for preparing the surface of a composite substrates, would break the fibers and degrade the mechanical properties of the composite. In addition, polymeric materials generally have very low free surface energy compared to metallic materials, and this deposition of a metallic coating layer with high adhesion strength is very difficult.

Using an appropriate preparation method prior to the coating deposition process typically improves the coating adhesion strength and deposition efficiency during spraying. Different surface treatment methods have been reported for the preparation of composite substrates. For example, grit blasting has been used for preparing the carbon-fiber-reinforced polymer composite (CFRP) substrate prior to the spraying of Zn using a plasma spray technique. After coating of CFRPs and examining their microstructure, it has been found that a lot of fibers were broken due to grit blasting and even some broken fibers penetrated to the coating structure. The shear bond strength of the coatings prepared using grit blasting has also been compared with the coatings prepared using abrasive papers, where it was found that using the latter preparation method results in poor mechanical properties. Chemical treatment is another method that has been used for preparing CFRP substrates prior to the coating deposition process. In this method, the substrates surface energy is increased by exposing them to chemical materials and solutions. Investigations into determining the effects of surface preparation methods on the air-plasma-sprayed Cu coatings' adhesion strength and quality have been performed, where the CFRP substrates were treated mechanically (grit blasting), thermally, and chemically. It has been found that using chemical treatment leads to better coating adhesion strengths, especially in the case of thin film coatings. Other methods, like the incorporation of granular particles on top of the polymeric substrates have been used for roughening and activating the composite substrates. Studies have been done about the metallization of Glass-fiber-reinforced polymer composite GFRPs for use as a heating element and de-icing applications. During such studies, a layer of #220 grit garnet sand and high strength epoxy adhesive mixture was applied manually on top of a [0₂₀] ply GFRP sample for increasing the surface roughness and consequently improving the coating adhesion during the deposition of a NiCrAlY coating layer using flame spray technique. The microscopic cross-section of the NiCrAlY-coated composite sample showed that the coating was very non-uniform. After connecting the coated sample to a power source for testing its performance as a heating element, it was observed that the non-uniformity of coating contributes to a non-uniform surface temperature distribution along the coating surface and the formation of hot and cold zones at the same time.

The number of research studies that have been done up to now about the thermal spray coating of composites are very low, and in most cases, low melting-point metallic powders (e.g. Zn and Al) have been used as the coating materials for spraying the composites. For instance, APS techniques have been utilized for the deposition of Al as a bond-coat and Al₂O₃ as a top-coat onto PMC substrates for enhancing their mechanical properties. The metallic coatings were sprayed onto several composite substrates using different spray parameters (different currents and spray distances). After examining the coated samples, it was found that the spray parameters played a very significant role in determining the microstructure, phase composition, and mechanical properties of the coated samples. The maximum shear adhesion strength achieved for the Al bond-coat was about 5.21 MPa. In another study, plasma spraying was used for the deposition of Zn, Al, Cu, and Ni₃Al coatings onto CFRP substrates. After the coating process, the microstructure and shear adhesion strength of the coated samples were analyzed. The results demonstrated that deposition of Ni₃Al and Cu leads to the formation of delamination in the interface of the substrate and coating due to the relatively high melting point of coating materials and low surface energy of the CFRP substrate. However, Al and Zn were deposited successfully. In addition, by comparing the plasma-sprayed Al and Zn with arch-sprayed Al and Zn, it was found that using plasma spraying results in the fabrication of a coating with superior mechanical properties. In another study, a combination of plasma spraying and cold spraying was used to deposit an aluminum coating layer onto CFRP substrates for lightning protection applications in aircrafts. In that study, a thin layer of aluminum coating (about 15 μm) was deposited onto the composite surface by using plasma spraying, and after that cold spraying was used for the deposition of a second aluminum layer as a top-coat. The plasma spray process was not used alone for the deposition of the whole coating due to the fact that the gas temperature in this process is high and it would increase the oxidation of sprayed particles, which would consequently increase the electrical resistivity of the coating, which is not desirable in the fabrication of a lightning protector coating. In addition, when the cold spray method was used alone for the coating of CFRPs, the coatings started peeling off once their thickness reached about 30 μm due to damage induced to the CFRPS surface by the impact of high-velocity particles.

### SUMMARY OF THE INVENTION

In accordance with the present invention, there is provided:
1. A composite substrate comprising a mesh layer and a composite material layer, wherein the mesh layer comprises a mesh material and an adhesive, said adhesive permeating the mesh material and adhering the mesh material directly to a surface of the composite material layer.
2. The composite substrate of item 1, wherein the composite material layer comprises at least one polymeric composite material, such as a carbon/graphite reinforced composite material, a glass reinforced composite material, a Kevlar reinforced composite material, or a boron reinforced composite material.
3. The composite substrate of item 1 or 2, wherein the composite material layer comprises a thermoplastic composite or a thermoset composite, preferably a thermoset composite.
4. The composite substrate of any one of items 1 to 3, wherein the composite material layer comprises reinforcing fibers embedded therein, preferably glass fibers, ceramic fibers, or carbon fibers.
5. The composite substrate of any one of items 1 to 4, wherein the composite material layer comprises a glass-fiber-reinforced polymer composite (GFRP).
6. The composite substrate of item 1, wherein the composite material layer is a polymeric composite layer, such as a carbon/graphite reinforced composite layer, a glass reinforced composite layer, a Kevlar reinforced composite layer, or a boron reinforced composite layer.
7. The composite substrate of item 6, wherein the composite material layer is a thermoplastic composite layer or a thermoset composite layer, preferably a thermoset composite layer.
8. The composite substrate of item 7, wherein the composite material layer is a glass-fiber-reinforced polymer composite (GFRP) layer.
9. The composite substrate of any one of items 1 to 8, wherein the mesh material is made of carbon fibers, ceramic fibers, glass fibers, or metal.
10. The composite substrate of any one of items 1 to 9, wherein the mesh material is made of metal, preferably stainless steel.
11. The composite substrate of any one of items 1 to 10, wherein the adhesion strength of the mesh layer to the composite material layer is between about 10 MPa and about 30 MPa, preferably between about 14 MPa to about 22 MPa.
12. The composite substrate of any one of items 1 to 11, wherein the adhesion strength of the mesh layer to the composite material layer is at least about 10 MPa; at least about 12 MPa; at least about 14 MPa; at least about 16 MPa; or at least about 20 MPa; and/or at most about 30 MPa; at most about 28 MPa; at most about 26 MPa; at most about 24 MPa; at most about 23 MPa; or at most about 22 MPa.
13. The composite substrate of any one of items 1 to 12, wherein the adhesion strength of the metal layer to the composite substrate is about 20 MPa or about 22 MPa.
14. The composite substrate of any one of items 1 to 13, wherein the mesh size is at least about 50 and at most about 700, preferably at least about 200 and at most about 400.
15. The composite substrate of any one of items 1 to 14, wherein the mesh material has a mesh size of at least about 50; at least about 100; at least about 150; at least about 175; or at least about 200; and/or at most about 700; at most about 600; at most about 500; or at most about 400.
16. The composite substrate of any one of items 1 to 15, wherein the mesh is completely embedded in the adhesive, such that none of the mesh material is exposed to the environment.
17. The composite substrate of any one of items 1 to 15, wherein the mesh is partially embedded in the adhesive, such that portions of the mesh material opposite the composite layer are exposed to the environment.
18. The composite substrate of any one of items 1 to 15, wherein the mesh layer has been roughened, preferably using abrasive particles, even more preferably using abrasive grit blasting, such that the mesh material is at least partially exposed to the environment.
19. The composite substrate of any one of items 1 to 18, wherein the adhesive is a thermosetting resin system in either liquid or film form, preferably an epoxy resin such as FM300 film adhesive.
20. A metal-coated composite substrate comprising a composite substrate as defined in any one of items 1 to 19, and a metal layer covering a side of the mesh layer opposite the composite layer.
21. The metal-coated composite substrate of item 20, wherein the surface of the mesh layer opposite the composite layer is roughened.
22. The metal-coated composite substrate of item 20 or 21, wherein the surface roughness of the surface of the mesh layer opposite the composite layer before the metal is deposited thereon is between about 4 μm and about 15 μm, preferably about 7 μm and about 11 μm.
23. The metal-coated composite substrate of any one of items 20 to 22, wherein the surface roughness of the surface of the mesh layer opposite the composite layer before the metal is deposited is at least about 4 μm; at least about 5 μm; at least about 6 μm; at least about 7 μm; or at least about 8 μm; and/or at most about 15 μm; at most about 13 μm; at most about 12 μm; or at most about 11 μm.
24. The metal-coated composite substrate of any one of items 20 to 23, wherein the metal layer is a layer of nickel, chromium or alloys thereof (such as FeCrAlY), including mixed NiCr alloys, preferably NiCrAlY, or a layer of stainless steel.
25. The metal-coated composite substrate of any one of items 20 to 24, wherein the metal layer is a layer of NiCrAlY.
26. The metal-coated composite substrate of any one of items 20 to 25, wherein the metal layer is between about 5 μm and about 150 μm thick, preferably about 30 μm and about 100 μm.
27. The metal-coated composite substrate of any one of items 20 to 26, wherein the thickness of the metal layer is at least about 5 μm; at least about 10 μm; at least about 20 μm; at least about 30 μm; or at least about 40 μm; and/or at most about 150 μm; at most about 130 μm; at most about 120 μm; at most about 110 μm; at most about 100 μm; or at most about 90 μm.
28. The metal-coated composite substrate of any one of items 20 to 27, wherein the uniformity of the thickness of the metal layer is between about ±1% and about ±10%, preferably between about ±2 and about ±8%.
29. The metal-coated composite substrate of any one of items 20 to 28, wherein the uniformity of the thickness of the metal layer is at least about ±0.5%; at least about ±1%; at least about ±1.5%; at least about ±2%; or at least about ±2.5%; and/or at most about ±15%; at most about ±10%; at most about ±8%; at most about ±6%; or at most about ±4%. In preferred embodiments, the porosity is about ±2.5%.
30. The metal-coated composite substrate of any one of items 20 to 29, wherein the adhesion strength of the metal layer to the composite substrate is between about 10 MPa and about 30 MPa, preferably between about 14 MPa to about 22 MPa.
31. The metal-coated composite substrate of any one of items 20 to 30, wherein the adhesion strength of the metal layer to the composite substrate is at least about 10 MPa; at least about 12 MPa; at least about 14 MPa; at least about 16 MPa; or at least about 20 MPa; and/or at most about 30 MPa; at most about 28 MPa; at most about 26 MPa; at most about 24 MPa; at most about 23 MPa; or at most about 22 MPa.
32. The metal-coated composite substrate of any one of items 20 to 31, wherein the adhesion strength of the metal layer to the composite substrate is about 20 MPa or about 22 MPa.
33. The metal-coated composite substrate of any one of items 20 to 32, wherein the electrical resistivity of the metal layer is between about 1.5 μΩ·m and about 3 μΩ·m, preferably between about 2 μΩ·m and about 2.3 μΩ·m.
34. The metal-coated composite substrate of any one of items 20 to 33, wherein the electrical resistivity is at least about 1.5 μΩ·m; at least about 1.7 μΩ·m; at least about 1.8 μΩ·m; at least about 1.9 μΩ·m; or at least about 2.0 μΩ·m; and/or at most about 3.0 μΩ·m; at most about 2.8 μΩ·m; at most about 2.6 μΩ·m; at most about 2.5 μΩ·m; at most about 2.4 μΩ·m; or at most about 2.3 μΩ·m.
35. The metal-coated composite substrate of any one of items 20 to 34, wherein the electrical resistivity of the metal layer is about 2.3 μΩ·m.
36. The metal-coated composite substrate of any one of items 20 to 35, wherein the sheet resistance of the metal layer is between about 0.01 Ω/square and about 0.08 Ω/square, preferably between about 0.02 Ω/square and about 0.06 Ω/square.
37. The metal-coated composite substrate of any one of items 20 to 36, wherein the sheet resistance is at least about 0.01 Ω/square; at least about 0.02 Ω/square; at least about 0.025 Ω/square; at least about 0.03 Ω/square; or at least about 0.05 Ω/square; and/or at most about 0.10 Ω/square; at most about 0.09 Ω/square; at most about 0.08 Ω/square; at most about 0.07 Ω/square; or at most about 0.06 Ω/square.
38. The metal-coated composite substrate of any one of items 20 to 37, wherein the sheet resistance is about 0.058 Ω/square.
39. The metal-coated composite substrate of any one of items 20 to 38, wherein the degree of porosity of the metal layer is between about 0.5% and about 40%, preferably between about 0.5% and about 20%, more preferably between about 0.5% and about 10%, even more preferably between about 1% and about 6%.
40. The metal-coated composite substrate of any one of items 20 to 39, wherein the porosity is at least about 0.5%; at least about 2%; at least about 5%; at least about 8%; or at least about 10%; and/or at most about 40%; at most about 30%; at most about 20%; at most about 15%; or at most about 10%.
41. The metal-coated composite substrate of any one of items 20 to 40, wherein the porosity is about 6.4%.
42. The metal-coated composite substrate of any one of items 20 to 41, wherein the degree of oxidation of the metal layer is between about 5% and about 40%, preferably between about 10% and about 32%.
43. The metal-coated composite substrate of any one of items 20 to 42, wherein the oxidation is at least about 5%; at least about 7%; at least about 10%; at least about 15%; at least about 20%; or at least about 30%; and/or at most about 60%; at most about 50%; at most about 40%; at most about 35%; or at most about 30%.
44. The metal-coated composite substrate of any one of items 20 to 43, wherein the oxidation is about 31.6%.
45. The metal-coated composite substrate of any one of items 20 to 44, wherein, when a 6 amp current is passed through the metal layer, the intensity generated in the metal layer is at least about 1.4 KW/m², preferably at least about 1.6 KW/m², more preferably at least about 1.8 KW/m², and most preferably about 4.3 KW/m².
46. The metal-coated composite substrate of any one of items 20 to 45, wherein, when a 9 amp current is passed through the metal layer, the intensity generated in the metal layer is at least about 3.3 KW/m², preferably at least about 3.6 KW/m², more preferably at least about 4.1 KW/m², and most preferably about 9.6 KW/m².
47. The metal-coated composite substrate of any one of items 20 to 46, wherein, when a 12 amp current is passed through the metal layer, the intensity generated in the metal layer is at least about 5.6 KW/m², preferably at least about 6.5 KW/m², more preferably at least about 7.2 KW/m², and most preferably about 17.2 KW/m².
48. A method for producing the composite substrate as defined in any one of items 1 to 19, comprising the step of adhering a mesh material to a surface of a composite material layer using an adhesive, said adhesive at least partially permeating the mesh material, thereby adhering the mesh material to the composite material layer, and thereby producing the composite substrate.
49. The method according to item 48, wherein a preexisting coating is removed to expose a surface the composite material layer prior to the adhering step, after which the mesh layer is adhered directly to said surface of the composite material layer.
50. The method according to item 48 or 49, wherein the adhering step is performed using vacuum bagging.
51. The method according to any one of items 48 to 50, wherein enough adhesive is used during the adhering step such that the mesh material is completely embedded in the adhesive and none of the mesh material is exposed to the environment.
52. The method according to any one of items 48 to 51, wherein a roughing step is performed on a surface of the mesh material opposite the composite material layer prior to the adhering step, preferably abrasive grit blasting, preferably with alumina grit having an average diameter of about 80 μm.
53. The method according to item 52, wherein the roughening step exposes a sufficient amount of the mesh material, without removing or damaging the mesh material.
54. The method according item 52 or 53, wherein the mesh size of the mesh material is large enough to prevent the sand particles of the grit blasting from easily penetrating the mesh layer.
55. A method for producing the metal-coated composite substrate as defined in any one of items 20 to 47, comprising the step of depositing a metal layer onto the mesh layer of the composite substrate as defined in any one of items 1 to 19, thereby forming the metal-coated composite substrate.
56. The method according to item 55, wherein a starting material for the metal layer is a metal powder, preferably a fine metal powder or a coarse metal powder.
57. The method according to item 56, wherein the metal powder is a NiCrAlY powder, more preferably a fine NiCrAlY powder (such as Amdry 9624, Oerlikon, size distribution: −37+11 μm) or a coarse NiCrAlY powder (such as Amdry 9625, Oerlikon. size distribution: −74+45 μm).
58. The method according to any one of items 55 to 57, wherein the depositing step is performed using thermal spray techniques, more preferably Air Plasma Spray (APS) techniques, preferably using a 3 MB plasma spray gun (Sulzer Metco, Westbury, N.Y.).
59. The method according to item 58, wherein, during thermal spraying, the gases and particles are cooled down, such as by using air amplifiers and air blowers to keep the substrates' surface temperature as low as possible during spraying (such as below the composite material layer's curing temperature, if said layer is a thermoset composite).
60. The method according to item 58 or 59, wherein, during the ASP, the current used is between about 300 and about 500 A, preferably about 400 or about 500 A, more preferably about 400 A; the voltage is about 60 V; the primary gas is Argon; the primary gas flow rate is about 43.8 L/min; the secondary gas is H₂; the secondary gas flow rate is about 6.57 L/min; the powder feed rate is between about 30 g/min and about 70 g/min, preferably about 32 g/min or about 64 g/min, more preferably about 64 g/min; the spray distance is between about 12 cm and about 16 cm, preferably about 13 cm or about 15 cm, more preferably about 13 cm; the robot speed is about 1 m/s, and the number of passes is between about 3 and about 20, preferably 3, 4, 5, or 10, more preferably 3 or 4.
61. The method according to any one of items 55 to 60, wherein, before the metal layer is deposited onto the mesh layer of the composite substrate, the mesh layer is roughened.
62. The method according to any one of items 48 to 61, wherein the composite material layer is provided from an existing part or structure.
63. Use of the metal-coated composite substrate as defined in any one of items 20 to 47 as an electro-thermal heating element, such as a de-icer or anti-icer.
64. Use of item 63 in the aerospace industry (e.g. aircrafts) or the energy industry (e.g. wind turbines).
65. Method of using the metal-coated composite substrate as defined in any one of items 20 to 47, the method comprising passing a current through the metal layer so as to generate heat in the metal layer.

### BRIEF DESCRIPTION OF THE DRAWINGS

In the appended drawings:

FIG. 1 shows steps of a method of producing a metal-coated composite substrate according to an embodiment of the present invention, specifically (a) a mesh material placed on a surface of a composite material layer, (b) a composite substrate according to an embodiment of the present invention, (c) a composite substrate with a roughened surface according to an embodiment of the present invention, and (d) a metal-coated composite substrate according to an embodiment of the present invention.

FIG. 2 shows steps of a method of producing a metal-coated composite substrate according to an embodiment of the present invention, using and existing part or structure, specifically (a) a mesh material placed on a surface of a composite material layer, (b) a composite substrate according to an embodiment of the present invention, (c) a composite substrate with a roughened surface according to an embodiment of the present invention, and (d) a metal-coated composite substrate according to an embodiment of the present invention.

FIG. 3 shows a method of use of a metal-coated composite substrate according to an embodiment of the present invention, specifically (a) a method of use of a metal-coated composite substrate made from a newly fabricated structure or part, and (b) a method of use of a metal-coated composite substrate made from an existing structure or part.

FIG. 4 shows (a) a 200 mesh plate according to an embodiment of the present invention, (b) a 400 mesh plate according to an embodiment of the present invention, and (c) a conventional composite plate.

FIG. 5 shows a grit-blasted 200 mesh substrate after coating according to an embodiment of the present invention.

FIG. 6 shows a schematic view of four-point probe method.

FIG. 7 shows low magnification (left side) and high magnification (right side) microscopic images of the cross-section of a) a 200 mesh substrate according to an embodiment of the present invention and b) a 400 mesh substrate according to an embodiment of the present invention after fabrication.

FIG. 8 shows a conventional composite substrate after grit blasting.

FIG. 9 shows confocal images of the top surface of the grit-blasted 200 mesh substrates according to an embodiment of the present invention using different grit-blasting parameters, specifically (a) 76 psi and 200 seconds; (b) 50 psi and 90 seconds; and (c) 76 psi and 150 seconds.

FIG. 10 shows confocal images of the top surface of the grit-blasted 400 mesh substrates according to an embodiment of the present invention using different grit-blasting parameters, specifically (a) 76 psi and 90 seconds; (b) 60 psi and 80 seconds; and (c) 66 psi and 180 seconds.

FIG. 11 shows burnt samples after coating, (a) a conventional composite substrate, (b) 200 mesh substrate without grit blasting according to an embodiment of the present invention, and (c) grit-blasted 200 mesh substrate according to an embodiment of the present invention.

FIG. 12 shows cross-sections of a coated grit-blasted 400 mesh substrate according to an embodiment of the present invention (a) low magnification, and (b) high magnification.

FIG. 13 shows cross sections of a) grit-blasted conventional composite, b) a not grit-blasted 200 mesh according to an embodiment of the present invention, c) a grit-blasted 200 mesh according to an embodiment of the present invention, and d) a grit-blasted 400 mesh substrate after coating according to an embodiment of the present invention.

FIG. 14 shows a cross-section of a coated (a) grit-blasted 400 mesh substrate according to an embodiment of the present invention, (b) grit-blasted 200 mesh substrate according to an embodiment of the present invention, and (c) a grit-blasted conventional stainless steel block with high magnification.

FIG. 15 shows cross-sections of (a) a grit-blasted 200 mesh substrate according to an embodiment of the present invention, and (b) a coated grit-blasted 400 mesh substrate according to an embodiment of the present invention.

FIG. 16 shows cross-sections of (a) and (c) a grit-blasted 200 mesh substrate according to an embodiment of the present invention with low and high magnifications, (b) and (d) a grit-blasted 400 mesh substrate according to an embodiment of the present invention with low and high magnifications.

FIG. 17 shows cross-sections of a coated grit-blasted 200 mesh substrate according to an embodiment of the present invention with, (a) low, and (b) high magnifications.

FIG. 18 shows adhesion strength results of the coated samples according to embodiments of the present invention.

FIG. 19 shows failure modes in coated samples according to embodiments of the present invention in which, (a) a 400 mesh composite, and (b) a 200 mesh composite were used as the substrate.

FIG. 20 shows V-I graphs of the coated composite samples according to embodiments of the present invention.

FIG. 21 shows generated intensity in the coated samples according to embodiments of the present invention for different current values.

FIG. 22 shows infrared pictures of the surface temperature distribution of the coatings according to embodiments of the present invention with (a) non-uniform, and (b) uniform thicknesses.

### DETAILED DESCRIPTION OF THE INVENTION

There is provided a composite substrate comprising a mesh layer and a composite material layer, wherein the mesh layer comprises a mesh material and an adhesive, said adhesive permeating the mesh material so as to adhere the mesh material to the composite material layer. There is also provided a method for producing said composite substrate.

The present inventors discovered that a composite substrate comprising a mesh layer makes for an effective substrate on which to apply a metal coating, as the mesh material will protect the underlying composite material layer during the coating process and at the same time will act as an anchor to keep the eventual metal coating on the surface of the composite substrate. Once coated with a metal layer, the composite substrate makes for an effective electro-thermal heating element, such as a de-icer or anti-icer.

The present inventors have also discovered a process of producing the above composite substrate, as well as a process for coating said composite substrate with a metal layer. Specifically, the inventors have discovered effective coating parameters with which the metal layer can be applied to the composite substrate. Said coating parameters allow for the deposition of a metal layer that is of sufficiently uniform thickness, with strong adhesion strength to the composite substrate, with high mechanical strength, high resistance to galvanic corrosion, and/or with high electrical resistivity. This process may also allow for high deposition efficiency.

This composite substrate, the metal-coated composite substrate, and the processes for producing the composite substrate and the metal-coated composite substrate create new opportunities for the design of electro-thermal heating elements, such as a de-icers or anti-icers.

### Composite Substrate Comprising a Mesh Layer and a Composite Material Layer

In a first aspect of the invention, a composite substrate comprising a mesh layer and a composite material layer is provided, wherein the mesh layer comprises a mesh material and an adhesive, said adhesive permeating the mesh material and adhering the mesh material directly to a surface of the composite material layer.

As stated, the composite substrate comprises a mesh layer and a composite material layer. As previously stated, the composite substrate of the present invention is intended to be used as a substrate on which to apply a metal coating, as the mesh material will protect the underlying composite material layer during the coating process and at the same time will act as an anchor to keep the metal coating on the surface of the composite substrate.

The dimensions of the composite substrate will largely be determined by the dimensions of the mesh layer and the composite material layer. The skilled person would understand that the composite substrate could come in a variety of sizes and shapes depending on the desired applications thereof. For example, if the composite substrate is intended to be used as part of a blade of a wind turbine, then the composite substrate will be dimensioned and sized for that purpose.

The composite material layer of the composite substrate refers to the layer of material underlying the mesh layer. It is to be understood that the composite material layer may be made of a variety of materials, depending on the desired applications thereof. The shape, size, and thickness of the composite substrate and the composite material layer will also be determined by the intended application of the composite substrate. For example, if the composite substrate is intended to be used as part of a blade of a wind turbine, then the composite material layer can be made of composite polymer materials typically used for such an application; the composite material layer will also be dimensioned and sized to be used as part of a blade of a wind turbine. The composite material layer can also be the surface of an object, for example the surface of the blade of a wind turbine.

In embodiments, the composite material layer comprises polymeric composite materials. Examples of polymeric composite materials include carbon/graphite reinforced composite materials, glass reinforced composite materials, Kevlar reinforced composite materials and boron reinforced composite materials. In preferred embodiments, the composite material layer comprises a thermoplastic composite or a thermoset composite, preferably a thermoset composite.

In preferred embodiments, the composite material layer comprises reinforcing fibers embedded therein, preferably glass fibers, ceramic fibers, or carbon fibers. Said reinforcing fibers are typically used to increase the mechanical strength of such composite materials. The composite material layer can comprise a dispersion of reinforcing fibers in a matrix, preferably a polymer matrix. In a more preferred embodiment, the composite material layer comprises a glass-fiber-reinforced polymer composite (GFRP).

The mesh layer is a layer of the composite substrate that comprises a mesh material that has been adhered to the composite material layer using an adhesive. In order to properly secure the mesh material to the composite material layer, the adhesive permeates the mesh material.

As previously stated, when a metal coating is applied to the composite substrate, the mesh material of the mesh layer will protect the underlying composite material layer during the coating process (namely during grit blasting and other similar surface preparation processes) and at the same time will act as an anchor to keep the metal coating on the surface of the composite substrate. A mesh material is typically made of a woven wire. For the purposes of the present invention, the mesh material is made of sufficiently strong material that can be properly adhered to the composite material layer using an adhesive, and that can properly anchor any intended metal coatings. In embodiments, the mesh material is made of carbon fibers, ceramic fibers, glass fibers, or metal. In preferred embodiments, the mesh material is made of metal, preferably stainless steel.

The mesh size of the mesh material will influence various properties of both the composite substrate and any metal coating that may be deposited thereon (see below for more detail). Mesh size typically refers to the number of openings in the material per one linear inch of material. For example, a mesh material with a mesh size of 100 has 100 openings per linear inch of material. The mesh size of the mesh material should be small enough so as to allow the chosen adhesive to penetrate and permeate the mesh material, as this will help adhere the mesh material to the composite material layer, and it will facilitate the process of producing the composite substrate of the present invention (as the adhesive can be applied to the mesh material after the mesh material has been placed on the top surface of the composite material layer, such that the adhesive will penetrate the mesh material and come into contact with the composite material layer).

In general, the size of the mesh affects the resulting adhesion strength between the mesh layer and the composite material layer. In embodiments, the adhesion strength of the mesh layer to the composite material layer is between about 10 MPa and about 30 MPa, preferably between about 14 MPa to about 22 MPa. In embodiments, the adhesion strength of the mesh layer to the composite material layer is at least about 10 MPa; at least about 12 MPa; at least about 14 MPa; at least about 16 MPa; or at least about 20 MPa; and/or at most about 30 MPa; at most about 28 MPa; at most about 26 MPa; at most about 24 MPa; at most about 23 MPa; or at most about 22 MPa. In preferred embodiments, the adhesion strength of the metal layer to the composite substrate is about 20 MPa or about 22 MPa. For clarity, the above-listed adhesion strength values are measured using a flatwise tensile test, preferably as described in the experimental section below.

While lower mesh sizes generally improve adhesion strength, the mesh size should be sufficiently high to allow the mesh material to better protect the underling composite material layer. For example, if the composite substrate is subjected to abrasive grit blasting in order to roughen the surface thereof, it is important that the mesh hole dimensions be smaller than the grit blasting sand diameter, so as to prevent the sand from easily penetrating the mesh layer and reaching the composite material layer, as this could damage the composite material layer.

In embodiments, the mesh size is at least about 50 and at most about 700, preferably at least about 200 and at most about 400. In embodiments, the mesh material has a mesh size of at least about 50; at least about 100; at least about 150; at least about 175; or at least about 200; and/or at most about 700; at most about 600; at most about 500; or at most about 400.

The adhesive used must sufficiently adhere the mesh material to the composite material layer. In addition, in embodiments, the mesh is completely embedded in the adhesive, such that none of the mesh material is exposed to the environment. In alternative embodiments, the mesh is partially embedded in the adhesive, such that portions of the mesh material opposite the composite layer are exposed to the environment.

Also, the adhesive should be a material that can be sufficiently roughened or removed without removing or damaging the mesh material. For example, in the event that the composite substrate of the present invention is subjected to abrasive grit blasting, the adhesive should be chosen such that said adhesive can be roughened and partially removed, thereby exposing more of the mesh material.

In embodiments, the mesh layer of the composite substrate of the present invention has been roughened, preferably using abrasive particles, even more preferably using abrasive grit blasting, such that the mesh material is at least partially exposed to the environment (see subsequent section for more details).

The skilled person would understand that the adhesive can be a variety of adhesives known in the art. In embodiments, the adhesive can be different types of thermosetting resin systems in either liquid or film forms, preferably an epoxy resin such as FM300 film adhesive.

The thickness of the mesh layer will generally be about as thick as the mesh material, although the thickness of the layer may increase depending on how much adhesive is used.

The mesh layer is adhered directly to the composite material layer. This means that there are no additional layers of material between the composite material layer and the mesh layer.

### Metal-Coated Composite Substrate Comprising a Metal Layer, a Mesh Layer and a Composite Material Layer

In another aspect of the present invention, a metal-coated composite substrate is provided. The metal-coated composite substrate comprises a composite substrate, as defined in the section above, and a metal layer covering a side of the mesh layer opposite the composite layer.

As stated, the composite substrate of the metal-coated composite substrate is as defined in the section above. However, it should be mentioned that, if the mesh layer of the composite substrate has not been roughened, the surface of the mesh layer will preferably be roughened before the metal layer can be applied. The roughening of the mesh layer will expose the mesh material, thereby allowing the mesh material to better anchor the metal layer, thereby allowing for a better adhesion of the metal layer to the composite substrate.

In general, the higher the surface roughness of the mesh layer before the metal layer is applied, the better the adhesion strength of the metal layer to the mesh layer. In embodiments, the surface roughness of the mesh layer before the metal is deposited is between about 4 μm and about 15 μm, preferably about 7 μm and about 11 μm. In embodiments, the surface roughness of the mesh layer before the metal is deposited is at least about 4 μm; at least about 5 μm; at least about 6 μm; at least about 7 μm; or at least about 8 μm; and/or at most about 15 μm; at most about 13 μm; at most about 12 μm; or at most about 11 μm.

The metal layer can be made of a variety of metals. It should be noted that, as the metal-coated composite substrate of the present invention is intended to be used as an electro-thermal heating element, it is preferable that the selected metal has sufficiently high electronic resistivity such that it can more easily generate heat. In addition, the selected metal should be sufficiently resistive to galvanic corrosion and should have sufficient mechanical strength for use as an electro-thermal heating element. However, the skilled person would understand that different metals and alloys may possess different advantages and disadvantages in terms of electronic resistivity, galvanic corrosion, and mechanical strength. Accordingly, while it is preferable that the metal used will have high electronic resistivity, high resistance to galvanic corrosion, and high mechanical strength, the skilled person would understand other metals may be used depending on the intended applications of the metal-coated composite substrate.

In preferred embodiments, the metal layer is a layer of nickel, chromium or alloys thereof (such as FeCrAlY), including mixed NiCr alloys, preferably NiCrAlY, or a layer of stainless steel. In a most preferred embodiment, the metal layer is a layer of NiCrAlY. One advantage of using NiCrAlY is that the electrical resistance of the NiCrAlY layer is almost constant and independent of the coating surface temperature (at least from 25 to 150° C.).

The thickness of the metal layer will affect the properties of the resulting metal-coated composite substrate. In general, if the metal layer is too thick, the metal coating may not sufficiently adhere to the composite substrate. Indeed, in general, the metal layer adhesiveness to the composite substrate decreases with increasing thickness. In addition, a higher thickness will generally lower the electrical resistance of the metal layer.

In embodiments, the metal layer is between about 5 μm and about 150 μm thick, preferably about 30 μm and about 100 μm. In embodiments, the thickness of the metal layer is at least about 5 μm; at least about 10 μm; at least about 20 μm; at least about 30 μm; or at least about 40 μm; and/or at most about 150 μm; at most about 130 μm; at most about 120 μm; at most about 110 μm; at most about 100 μm; or at most about 90 μm.

In preferred embodiments, the metal layer is relatively uniform in thickness. This will allow for more uniform surface temperature distribution in the event that the metal-coated composite substrate is used as an electro-thermal heating element. In embodiments, the uniformity of the thickness of the metal layer is between about ±1% and about ±10%, preferably between about ±2 and about ±8%. In embodiments, the uniformity of the thickness of the metal layer is at least about ±0.5%; at least about ±1%; at least about ±1.5%; at least about ±2%; or at least about ±2.5%; and/or at most about ±15%; at most about ±10%; at most about ±8%; at most about ±6%; or at most about ±4%. In preferred embodiments, the porosity is about ±2.5%.

As mentioned, the presence of the metal mesh layer improves the adhesion of the metal layer to the composite substrate. This is important because it will reduce the likelihood of, and preferably prevent, the metal layer from tearing off when the metal-coated composite substrate is in use, for example as an electro-thermal heating element. In embodiments, the adhesion strength of the metal layer to the composite substrate is between about 10 MPa and about 30 MPa, preferably between about 14 MPa to about 22 MPa. In embodiments, the adhesion strength of the metal layer to the composite substrate is at least about 10 MPa; at least about 12 MPa; at least about 14 MPa; at least about 16 MPa; or at least about 20 MPa; and/or at most about 30 MPa; at most about 28 MPa; at most about 26 MPa; at most about 24 MPa; at most about 23 MPa; or at most about 22 MPa. In preferred embodiments, the adhesion strength of the metal layer to the composite substrate is about 20 MPa or about 22 MPa. For clarity, the above-listed adhesion strength values are measured using a flatwise tensile test, preferably as described in the experimental section below.

As mentioned, it is preferable that the metal layer has high electrical resistivity, as this will allow the metal layer to more effectively generate heat. It should be noted that electrical resistivity is directly proportional to electrical resistance. However, resistivity is an intrinsic property that unlike electrical resistance does not depend on the shape and dimensions of the material in question.

In embodiments, the electrical resistivity of the metal layer is between about 1.5 μΩ·m and about 3 μΩ·m, preferably between about 2 μΩ·m and about 2.3 μΩ·m. In embodiments, the electrical resistivity is at least about 1.5 μΩ·m; at least about 1.7 μΩ·m; at least about 1.8 μΩ·m; at least about 1.9 μΩ·m; or at least about 2.0 μΩ·m; and/or at most about 3.0 μΩ·m; at most about 2.8 μΩ·m; at most about 2.6 μΩ·m; at most about 2.5 μΩ·m; at most about 2.4 μΩ·m; or at most about 2.3 μΩ·m. In preferred embodiments, the electrical resistivity of the metal layer is about 2.3 μΩ·m.

It should be noted that it is also preferable for the metal layer to have high sheet resistance, which is a parameter used more frequently to characterize thin coatings. One distinction between sheet resistance and electrical resistance is that sheet resistance, much like electrical resistivity, is independent of size, thereby making it easier to compare the effectiveness of layers of differing thicknesses. In embodiments, the sheet resistance of the metal layer is between about 0.01 Ω/square and about 0.08 Ω/square, preferably between about 0.02 Ω/square and about 0.06 Ω/square. In embodiments, the sheet resistance is at least about 0.01 Ω/square; at least about 0.02 Ω/square; at least about 0.025 Ω/square; at least about 0.03 Ω/square; or at least about 0.05 Ω/square; and/or at most about 0.10 Ω/square; at most about 0.09 Ω/square; at most about 0.08 Ω/square; at most about 0.07 Ω/square; or at most about 0.06 Ω/square. In preferred embodiments, the sheet resistance is about 0.058 Ω/square.

For clarity, the above-listed electrical resistance, electrical resistivity, and sheet resistance values are measured using a four-point electrical probe technique, preferably as described in the experimental section below.

The skilled person would understand that various properties of the metal layer will affect its electronic resistivity, mechanical strength, and/or resistance to galvanic corrosion. For example, a higher degree of porosity and a higher degree of oxidation in the metal layer will generally increase electrical resistivity.

In embodiments, the degree of porosity of the metal layer is between about 0.5 and about 40%, preferably between about 0.5 and about 20%, more preferably between about 0.5 and about 10%, even more preferably between about 1% and about 6%. In embodiments, the porosity is at least about 0.5%; at least about 2%; at least about 5%; at least about 8%; or at least about 10%; and/or at most about 40%; at most about 30%; at most about 20%; at most about 15%; or at most about 10%. In preferred embodiments, the porosity is about 6.4%.

In embodiments, the degree of oxidation of the metal layer is between about 5% and about 40%, preferably between about 10% and about 32%. In embodiments, the oxidation is at least about 5%; at least about 7%; at least about 10%; at least about 15%; at least about 20%; or at least about 30%; and/or at most about 60%; at most about 50%; at most about 40%; at most about *35%; or at most about 30%. In preferred embodiments, the oxidation is about 31.6%.

When acting as a heating element, current is passed through the metal layer of the metal-coated composite substrate so as to cause the metal layer to generate heat. In preferred embodiments, when a 6 amp current is passed through the metal layer, the intensity generated in the metal layer is at least about 1.4 KW/m², preferably at least about 1.6 KW/m², more preferably at least about 1.8 KW/m², and most preferably about 4.3 KW/m². Similarly, in preferred embodiments, when a 9 amp current is passed through the metal layer, the intensity generated in the metal layer is at least about 3.3 KW/m², preferably at least about 3.6 KW/m², more preferably at least about 4.1 KW/m², and most preferably about 9.6 KW/m². Similarly, in preferred embodiments, when a 12 amp current is passed through the metal layer, the intensity generated in the metal layer is at least about 5.6 KW/m², preferably at least about 6.5 KW/m², more preferably at least about 7.2 KW/m², and most preferably about 17.2 KW/m².

For clarity, the above-listed intensity values are measured using a four-point electrical probe technique (and the equation

$$Intensity = \frac{P}{{A}_{S}} = \frac{1}{{A}_{s}} {RI}^{2} ) ,$$

preferably as described in the experimental section below.

Generally, the amount of intensity needed to be provided by the heating elements for de-icing purposes is in the range of 2.1-3.6 kW/m². Accordingly, the current used to generate heat in the metal layer can be modified depending on the characteristics of the metal layer. In general, though, it is preferable that the electrical resistivity of the metal layer be higher so that less current needs to be used to generate sufficient heat for de-icing or anti-icing purposes.

### Optional Additional Layers

In embodiments, the metal-coated composite substrate further comprises one or more additional layer(s) on a side of the metal layer opposite the mesh layer. It is preferable that these layers be as thin as possible, preferable between about 5 microns to about 10 microns, in order to avoid adding too much weight to the metal-coated composite substrate, as well as to ensure that the metal layer is as close to the external surface of the metal-coated composite substrate as possible. This is because, if the metal-coated composite substrate is to function as an electrothermal heating element, the portion of the metal-coated composite substrate that will generate heat (i.e. the metal layer) should be as close as possible to where ice is likely to form. If additional layers are too thick, this will prevent heat from reaching the external surface of the metal-coated composite substrate.

### Method of Producing Composite Substrate Comprising a Mesh Layer and a Composite Material Layer

In another aspect of the invention, a method for producing the above composite substrate comprising a mesh layer and a composite material layer is provided.

The method for producing the composite substrate thus comprises the step of:
adhering a mesh material to a surface of a composite material layer using an adhesive, said adhesive at least partially permeating the mesh material, thereby adhering the mesh material to the composite material layer, and thereby producing the composite substrate.

### Starting Materials

The starting materials can be the composite material layer, the mesh material, and the adhesive as defined in the previous section. It is generally understood that the resulting composite substrate can be modified for use as an electrothermal heating element (by depositing a metal layer thereon). Accordingly, the composite material layer can be provided by manufacturing and dimensioning a composite material layer according to the intended use of the composite substrate.

It is also understood that the above method can be used on existing parts and structures. This means that said existing parts and structures may be used as the composite material layer. However, if the existing part or structure has a preexisting coating (for example, an adhesive film has already been formed on the existing composite material layer), it is preferable that said preexisting coating be removed before the above method is performed to expose a surface of the composite material layer. This removal of the preexisting coating can be done using any known technique in the art (such as sand blasting), as long as it does not damage the underlying composite material layer.

As an example, many existing wind turbine blades are made of composite materials (i.e. a composite material layer), yet they do not comprise the composite substrate of the present invention. The above method can be used to modify said wind turbine blades so as to transform the existing composite material layer into the composite substrate of the present invention. If the existing composite material layer of the wind turbine already has a preexisting coating thereon (for example, an adhesive film), then said layer should be removed (for example, by sand blasting) before the above method is performed. This removal of preexisting coatings will help lighten the resulting composite substrate, and it will enable the mesh layer to be in direct contact with the composite material layer.

It is also understood that each of the composite material layer, the mesh material, and the adhesive can be provided and/or manufactured using any known method in the art.

### Adhering Step

In this step, the mesh material is adhered to the surface of a composite material layer using an adhesive, thereby forming the mesh layer. As mentioned previously, in order to increase the adhesion strength of the mesh material to the composite material layer, the adhesive should permeate the mesh material as much as possible. This step can be performed using any known method in the art.

In preferred embodiments, the adhering step is performed using vacuum bagging. Vacuum bagging typically consists of four primary items, including peel ply and release film, breather and bleeder cloth, vacuum bagging film, and a vacuum pump. After vacuum bagging, the setup can be transferred to an autoclave for a curing process under the sufficient pressure and temperature.

As mentioned in the previous section, in preferred embodiments, enough adhesive should be used such that the mesh material is completely embedded in the adhesive and none of the mesh material is exposed to the environment.

### Optional Roughing Step

As mentioned previously, the surface of the mesh layer can be roughened. This can be done using any known technique in the art, preferably abrasive grit blasting, preferably with alumina grit having an average diameter of about 80 μm. The resulting surface roughness of the composite substrate can be as defined in the previous sections.

As mentioned, the roughening of the mesh layer will expose the mesh material, thereby allowing the mesh material to better anchor a metal layer that will be formed, thereby allowing for a better adhesion of the metal layer to the composite substrate. Therefore, it is preferable that the roughening step expose a sufficient amount of the mesh material, without removing or damaging the mesh material.

When abrasive grit blasting is used, it is preferable to optimize the parameters of the abrasive grit blasting. However, the optimal parameters of the abrasive grit blasting will depend on the adhesive used and the mesh material used. For example, when a 200 steel mesh is used with an epoxy resin adhesive, the abrasive grit blasting should ideally be performed with a pressure of about 76 psi and for about 150 seconds. However, a pressure of 76 psi and a time of 200 seconds may damage or remove the steel wires, while a pressure of 50 psi and a time of 90 seconds could not remove enough epoxy to sufficiently expose the mesh material, thereby having a negative impact on coating adhesion and deposition efficiency of a metal layer.

Similarly, when a 400 steel mesh is used with an epoxy resin adhesive, the abrasive grit blasting should ideally be performed with a pressure of about 66 psi and for about 180 seconds. However, a pressure of 76 psi and a time of 90 seconds may damage or remove the steel wires, while a pressure of 60 psi and a time of 80 seconds could not remove enough epoxy to sufficiently expose the mesh material, thereby having a negative impact on coating adhesion and deposition efficiency of a metal layer.

In general, mesh materials with lower mesh sizes are less sensitive and vulnerable to grit blasting, as their wires are thicker and more resistant to the impact of high-velocity particles. In addition, lower mesh sizes generally result in higher surface roughness. This might be due to the relatively larger voids existing on mesh materials with lower mesh sizes. Accordingly, in general, using mesh materials of lower mesh sizes (for example, a mesh size of 200 compared to a mesh size of 400) results in a better coating deposition and adhesion during spraying of a metal layer.

As mentioned in the previous sections, the mesh layer protects the composite material layer during the roughening step. Accordingly, when grit blasting is used, it is preferable that the mesh size be large enough to prevent the sand particles of the grit blasting from easily penetrating the mesh layer, as this would result in damage to the composite material layer.

The skilled person would understand that, in general, increasing the pressure and time of abrasive grit blasting would remove more resin from the mesh layer, while decreasing the pressure and time of abrasive grit blasting will remove less resin.

If another roughening method is used other than abrasive grit blasting, the optimal parameters of said roughening method should be determined so as sufficiently roughen the mesh layer and expose a sufficient amount of the mesh material, without removing or damaging the mesh material.

### Method of Producing a Metal-Coated Composite Substrate Comprising a Metal Layer, a Mesh Layer and a Composite Material Layer

In another aspect of the invention, a method for producing the above metal-coated composite substrate comprising a metal layer, a mesh layer and a composite material layer is provided.

The method for producing the metal-coated composite substrate thus comprises the step of:
depositing a metal layer onto the mesh layer of the composite substrate as defined in the previous section, thereby forming the metal-coated composite substrate.

### Starting Materials

The starting materials can be the composite substrate as defined in the previous section. It is generally understood that the resulting metal-coated composite substrate can be used as an electrothermal heating element. Accordingly, the composite substrate can be provided by manufacturing and dimensioning a composite substrate according to the intended use of the metal-coated composite substrate.

As for the metal layer, the starting material can be any metal defined in the previous sections. As mentioned, the metal chosen will depend on the intended use of the metal-coated composite substrate, but generally it is preferable for the chosen metal to have high electric resistivity, high mechanical strength, and high resistance to galvanic corrosion. Preferably, the starting material for the metal layer is a metal powder, preferably a fine metal powder or a coarse metal powder. In preferred embodiments, the metal powder is a NiCrAlY powder, more preferably a fine NiCrAlY powder (such as Amdry 9624, Oerlikon, size distribution: −37+11 μm) or a coarse NiCrAlY powder (such as Amdry 9625, Oerlikon. size distribution: −74+45 μm).

The choice of starting material for the metal layer (for example, fine vs coarse metal powder) will somewhat affect the resulting metal layer that is formed on the composite substrate (see the following section for more details and examples). In general, using fine metal powders (as opposed to coarse metal powders) tends to result in a metal layer with lower porosity, higher oxidation, lower deposition efficiency (as in, when spray coating techniques are used, more passes are needed to arrive at coatings of similar thickness as those achieve with coarse metal powders), and tends to require fewer passes to achieve a relatively uniform thickness. However, overall, the use of finer metal powders tends to result in a metal layer of lower electronic resistivity (this could be because porosity likely affects resistivity more strongly than oxidation).

### Depositing Step

In this step, the metal layer is deposited onto the mesh layer of the composite substrate, thereby forming the metal-coated composite substrate. The resulting metal layer is as defined in the sections above. While this step can be performed using any known method in the art, it is preferable to use thermal spray techniques, more preferably Air Plasma Spray (APS) techniques, preferably using a 3 MB plasma spray gun (Sulzer Metco, Westbury, N.Y.).

If ASP techniques are used, the composite substrate (specifically the composite material layer) may be vulnerable to the high-temperature gases used and the impact of high-temperature particles. Accordingly, in preferred embodiments, the gases and particles are advantageously cooled down, such as by using air amplifiers and air blowers to keep the substrates surface temperature as low as possible during spraying (such as below the composite material layer's curing temperature, if said layer is a thermoset composite).

The parameters of the ASP used will naturally affect the resulting metal layer. In general, such parameters include current, voltage, primary gas (including flow rate thereof), secondary gas (including flow rate thereof), powder feed rate, spray distance, robot speed, and number of passes.

In preferred embodiments, the current used is between about 300 and about 500 A, preferably about 400 or about 500 A, more preferably about 400 A; the voltage is about 60 V; the primary gas is Argon; the primary gas flow rate is about 43.8 L/min; the secondary gas is H₂; the secondary gas flow rate is about 6.57 L/min; the powder feed rate is between about 30 g/min and about 70 g/min, preferably about 32 g/min or about 64 g/min, more preferably about 64 g/min; the spray distance is between about 12 cm and about 16 cm, preferably about 13 cm or about 15 cm, more preferably about 13 cm; the robot speed is about 1 m/s, and the number of passes is between about 3 and about 20, preferably 3, 4, 5, or 10, more preferably 3 or 4.

The skilled person would understand that the above parameters could be modified, and that said modifications may affect the resulting metal layer. What is important is that the resulting metal layer conforms to the definition provided above, that the metal layer is sufficiently strongly adhered to the composite substrate, and that the composite substrate is not damaged during the deposition process.

For example, if the current is too high, the powder feed rate is too high, or the spray distance is too low, the composite substrate may end up being burnt. However, if the current is high, other parameters can be adjusted (for example, the powder feed rate can be lowered, or the spray distance can be increased) in order to compensate (although this may impact other aspects of the deposition, such as deposition efficiency). What matters is that the surface temperature of the composite substrate does not become so hot so as to damage or burn the composite substrate.

As mentioned previously, the choice of metal powder, as well as the spray parameters, will affect the resulting metal layer. For example, increasing the number of passes will obviously increase the thickness of the resulting metal layer. However, if a coarse metal powder is used, each pass will increase the thickness of the metal layer by a greater amount than if a fine metal powder had been used (meaning the coarse metal powder has higher deposition efficiency). In general, more passes will increase deposition time, and weaken the adhesion strength of the metal layer to the composite substrate.

If a coarse NiCrAlY powder is used with a 400 stainless steel mesh, 5 passes with ASP (current of 400 A, voltage of 60 V, Argon flow rate of 43.8 L/min, H₂ flow rate of 6.57 L/min, powder feed rate of 64 g/min, spray distance of 13 cm, robot speed of 1 m/s) may result in the peeling off of the mesh material from the composite material layer.

If a coarse NiCrAlY powder is used, 3 passes with ASP (current of 400 A, voltage of 60 V, Argon flow rate of 43.8 L/min, H₂ flow rate of 6.57 L/min, powder feed rate of 64 g/min, spray distance of 13 cm, robot speed of 1 m/s) may result in a metal layer of non-uniform thickness (the thickness may become relatively uniform after at least 4 passes).

In general, use of a fine powder, when compared to a coarse metal powder, general has the following effect on the above method or the resulting metal layer:
a. Lower porosity;
b. Higher oxidation;
c. Lower deposition efficiency (as more passes are needed to achieve the same thickness);
d. Easier to control coating thickness (since each pass adds less overall thickness);
e. Greater uniformity of thickness (especially when the thickness is low, as shown in the experiment section below); and
f. Less penetration into the mesh material (this may be because coarse powder particles are notably heavier than the fine powder particles, and consequently, when they reach to the composite substrate, they have more momentum and penetrate more into the mesh material, thereby resulting in higher adhesion strength).

As mentioned, one advantage of the method above is that, due to the presence of the mesh layer (and the roughened surface caused by the surface roughening step, including holes created in the mesh material), the resulting metal layer is anchored to the composite substrate, thereby improving adhesion strength between the metal layer and the mesh layer.

In addition, the presence of the mesh layer helps prevent damage to the composite material layer during the deposition step (including when ASP is used).

It is also worth motioning that, using the above-defined method, the metal layer will be deposited directly on the composite substrate, without an intermediate layer.

### Optional Roughing Step

As mentioned previously, before the metal layer is deposited onto the mesh layer of the composite substrate, it is preferable that the mesh layer be roughened (if it has not already been roughened). This step is as defined in the previous sections.

### Optional Addition of Additional Layers

In embodiments, as previously mentioned, additional layers may be added to the metal layer. These additional layers are as defined in the previous sections, and they can be added using any known technique in the art.

### Advantages of the Invention

In developing the composite substrate and the metal-coated composite substrate of the present invention, the inventors discovered a composite substrate comprising a mesh layer that makes for an effective substrate on which to apply a metal coating, as the mesh material will protect the underlying composite material layer during the coating process and at the same time will act as an anchor to keep the metal coating on the surface of the composite substrate. Once coated with a metal layer, the composite substrate makes for an effective electro-thermal heating element, such as a de-icer or anti-icer.

In addition to the advantages previously discussed, the composite substrate and the metal-coated composite substrate of the present invention can present one or more of the following advantages:
The metal-coated composite substrate can be used as a heating element without adding significant weight to the composite material layer (only the weight of the mesh layer and metal layers are added);
The metal layer of the metal-coated composite substrate has high adhesion strength with the composite substrate, said adhesion strength being increased if the mesh layer has been roughened before the metal layer is deposited thereon.
The mesh layer of the composite substrate has high adhesion strength with the composite material layer.
A metal layer of relatively uniform thickness on the metal-coated composite substrate can provide for a heating element with a surface temperature distribution of high uniformity.
The metal layer on the metal-coated composite substrate may possess high electric resistivity (due in part to relatively high porosity and/or relatively high oxidation), which allows the metal layer to more easily generate heat, and allows the metal layer to achieve higher intensities with lower current values.
The metal layer on the metal-coated composite substrate may have high resistance to galvanic corrosion, and/or high mechanical strength.

The methods of the present invention produce the above-defined composite substrate and the metal-coated composite substrate.

The method of producing the composite substrate of the present invention results in a composite substrate where the mesh layer has relatively high adhesion strength with the composite material layer, and the method allows for the mesh layer to be roughened (using, for example, abrasive grit blasting) without damaging the composite material layer.

In addition, the method of producing a metal-coated composite substrate of the present invention may allow for the deposition a metal layer that is of sufficiently uniform thickness, with strong adhesion strength to the composite substrate, with high electrical resistivity, high mechanical strength, and/or resistance to galvanic corrosion. This process may also allow for high deposition efficiency, without damaging the composite material layer during the deposition of the metal layer (using, for example, ASP techniques) or during the roughing of the mesh layer (using, for example, abrasive grit blasting).

### Applications of the Metal-Coated Composite Substrate

As mentioned, the metal-coated composite substrate of the present invention can be used as an electro-thermal heating element, such as a de-icer or anti-icer. This applies to a vast number of structures, such as in the aerospace industry (e.g. aircrafts), and the energy industry (e.g. wind turbines).

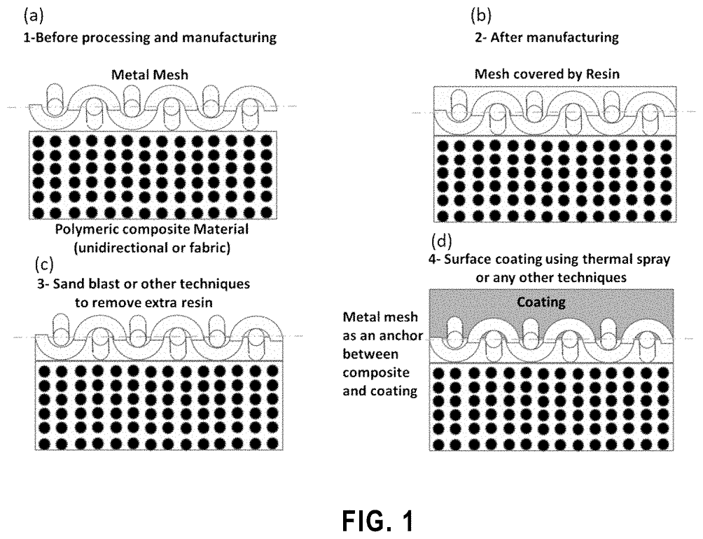

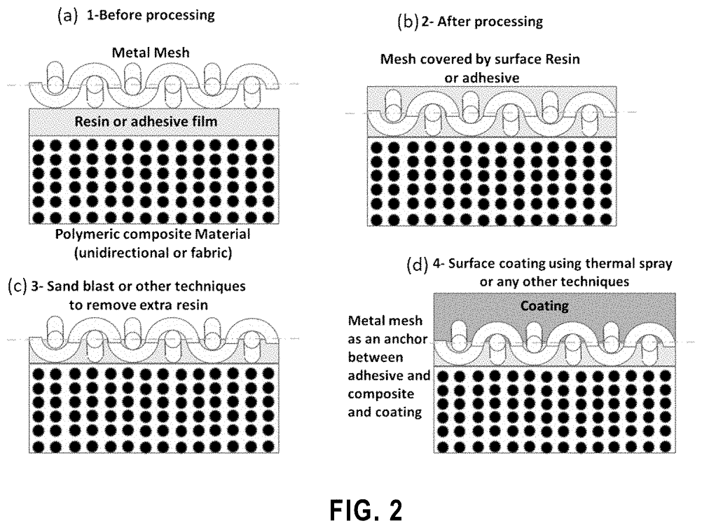

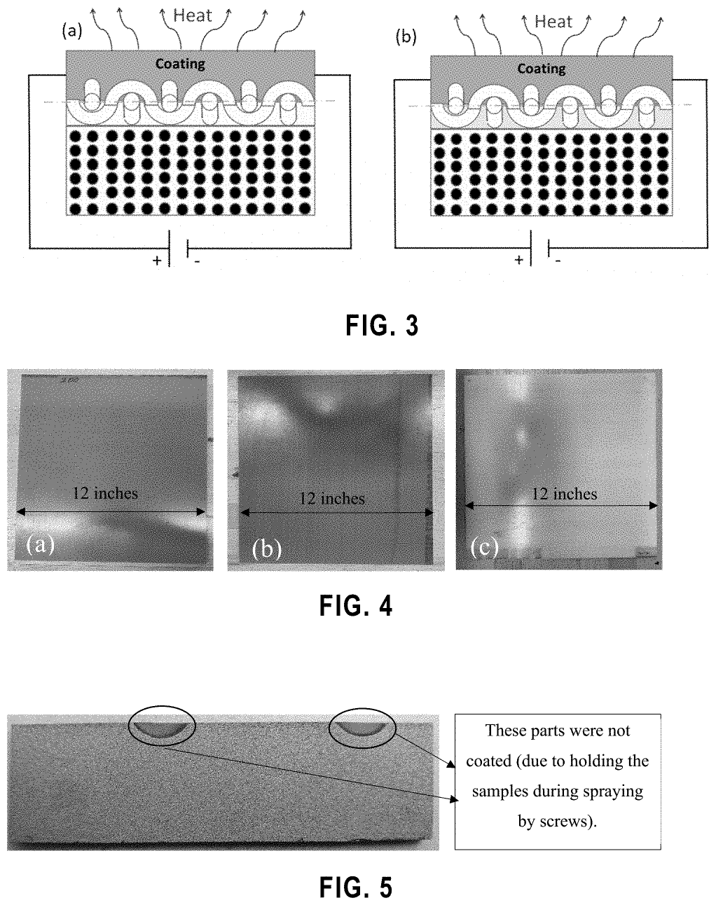

In addition, as previously mentioned, the methods of the present invention can be used on both newly constructed and previously existing structures as shown for example in FIG. 1 (newly fabricated structure) and FIG. 2 (existing structure or part). For example, a composite substrate can be manufactured from scratch and then coated in metal according to the methods of the present invention (for use on a newly constructed aircraft, for example). Alternatively, an existing part of, for example, an aircraft can be modified into a composite substrate according to the present invention (using the method of producing a composite substrate of the present invention), and then a metal layer can be deposited onto said composite substrate (using the method of producing a metal-coated composite substrate of the present invention). The metal-coated composite substrate can then be used as an electrothermal heating element, for example by passing current through the metal layer so as to generate heat (as shown for example in FIG. 3).

### Definitions

The use of the terms “a” and “an” and “the” and similar referents in the context of describing the invention (especially in the context of the following claims) are to be construed to cover both the singular and the plural, unless otherwise indicated herein or clearly contradicted by context.

The terms “comprising”, “having”, “including”, and “containing” are to be construed as open-ended terms (i.e., meaning “including, but not limited to”) unless otherwise noted.

Recitation of ranges of values herein are merely intended to serve as a shorthand method of referring individually to each separate value falling within the range, unless otherwise indicated herein, and each separate value is incorporated into the specification as if it were individually recited herein. All subsets of values within the ranges are also incorporated into the specification as if they were individually recited herein.

All methods described herein can be performed in any suitable order unless otherwise indicated herein or otherwise clearly contradicted by context.

The use of any and all examples, or exemplary language (e.g., “such as”) provided herein, is intended merely to better illuminate the invention and does not pose a limitation on the scope of the invention unless otherwise claimed.

No language in the specification should be construed as indicating any non-claimed element as essential to the practice of the invention.

Herein, the term “about” has its ordinary meaning. In embodiments, it may mean plus or minus 10% or plus or minus 5% of the numerical value qualified.

Unless otherwise defined, all technical and scientific terms used herein have the same meaning as commonly understood by one of ordinary skill in the art to which this invention belongs.

Other objects, advantages and features of the present invention will become more apparent upon reading of the following non-restrictive description of specific embodiments thereof, given by way of example only with reference to the accompanying drawings.

### DESCRIPTION OF ILLUSTRATIVE EMBODIMENT

The present invention is illustrated in further details by the following non-limiting examples.

Specifically, several experiments were performed, during which various substrates were prepared and coated with metal using a variety of parameters. The following section will first detail the methodology used to create the composite substrates that were tested, to create the metal-coated composite substrates that were tested, and to measure various properties thereof. The subsequent section will detail the results of these experiments.

### Experiment Methodology

The experiment methodology consists of four steps including, 1) fabrication and preparation of the composite substrate (specifically GFRP composite substrates), 2) deposition of a metal coating by using a plasma spray technique, 3) determination of the coatings adhesion strength, 4) electrical characterizations of the coated samples and analyzing their performance as a heating element.

### Part 1: GFRP Composite Substrate Fabrication and Preparation

In the first step, three 30 by 30 cm square plates were made using GFRP (Cytec E773FR, 5 Garret Mountain Plaza, Woodland Park, N.J. 07424 USA) prepreg plies and stainless steel mesh cloths. The GFRP prepregs were taken out of the freezer and left at the room conditions for about three hours. This allows the temperature of prepreg to rise to room temperature and the viscosity is reduced so that the prepregs can be cut into smaller sheets easier. After that, the prepregs were cut into 30 by 30 cm square sheets. For making a 4 mm thick composite plate, 16 unidirectional GFRP plies (i.e. [0₁₆] composite) were utilized. In order to protect the composite fibers from the impact of high-velocity particles during preparation and metal spraying (coating deposition step), woven wire #200 and #400 stainless steel mesh cloths (type 316) were incorporated as a top layer to the first and second plates, respectively. The properties of these steel mesh cloths are listed in Table 1 below. After stacking and aligning the prepregs and steel mesh cloths, they were placed on a tool and vacuum bagged. The vacuum bag setup consisted of four primary items, including peel ply and release film, breather and bleeder cloth, vacuum bagging film, and a vacuum pump. After vacuum bagging, the setup was transferred to an autoclave for the curing process under the pressure and temperature of 74.5 kPa and 120° C., respectively. FIG. 4 shows the fabricated composite plates.

TABLE 1
200 and 400 stainless steel mesh cloths properties

| Mesh | Nominal | Wire | Open | Weight |
|---|---|---|---|---|
| count | aperture | diameter | area (%) | kg/m² |
| 200 | 75 μm | 60 μm | 34 | 0.28 |
| 400 | 38 μm | 30 μm | 31 | 0.16 |

Once the composite plates were fabricated, they were cut into smaller samples using a diamond saw. In the next step, the composite substrates were roughened and prepared for the coating deposition process using grit blasting. In the grit blasting process, the abrasive particles that are sucked into a nozzle are accelerated toward the substrate surface using a pressurized gas stream. More than 30 samples were grit blasted to find an optimized set of parameters for each type of composite substrate. These substrates include the conventional composite substrate (without addition of any metallic mesh), the plate fabricated by addition of a 200 steel mesh cloth (hereafter will be called the “200 mesh substrate”), and the plate fabricated by addition of a 400 steel mesh cloth (hereafter will be called the “400 mesh substrate”). The optimized grit blasting parameters for each type of composite substrate are shown in Table 2. It should also be mentioned that the alumina grit used in the experiment had an average diameter of about 80 μm. It should be noted that while the term optimized is used both here and throughout this experimental section to refer to parameters, other parameters could be used.

TABLE 2
Optimized grit blasting parameters.

| | Grit blasting condition | | | |
|---|---|---|---|---|
| substrate | Pressure | Time | Standoff | Angle of grit |
| type | (psi) | (s) | distance (cm) | impact (degree) |
| Conventional | 68 | 120 | 6 | 90 |
| composite | | | | |
| 200 mesh | 76 | 150 | 6 | 90 |
| 400 mesh | 60 | 180 | 6 | 90 |

### Part 2: Coating of Composite Substrates

Once the optimized parameters were found for grit blasting of the composite substrates, Air Plasma Spray technique (APS) was used for the deposition of a metallic coating layer onto the composite substrates. Two types of NiCrAlY powders with the fine (Amdry 9624, Oerlikon, size distribution: −37+11 μm) and coarse (Amdry 9625, Oerlikon. size distribution: −74+45 μm) size distributions were utilized for spraying and fabrication of a heating element for the composite substrates. A 3 MB plasma spray gun (Sulzer Metco, Westbury, N.Y.) was also used to spray the NiCrAlY powders. Given that the composite substrates were vulnerable to the high-temperature gases and impact of high-temperature particles, they were cooled down using two air amplifiers and two air blowers to keep the substrates' surface temperature as low as possible during spraying (below the composite curing temperature). In the first step, four experiments were done for finding an appropriate set of spray parameters for the coating of the composite samples using fine NiCrAlY powder (see Table 3 below). It was found that coatings with high quality and adhesion could be generated using Exp 4 spray parameters. It was also found that acceptable coatings could be deposited by using Exp 4 parameters and the coarse NiCrAlY powder. Given that in the case of using coarse NiCrAlY powder, the coating thickness changed significantly with the number of passes, the composites were coated with three different numbers of passes (Exp 5-7 in Table 3). Upon the completion of the coating process, a metallographic technique was used for analyzing the microstructure of the coated samples under a microscope. After finding the proper spray parameters, larger composite samples (2.3-by-10 cm) were coated for the mechanical and electrical characterizations. FIG. 5 shows the image of a grit-blasted 200 mesh sample after coating by the coarse powder and using the Exp 6 spray parameters.

TABLE 3
The plasma spray parameters used for the coating of composite substrates

| | | | | | | | |
|---|---|---|---|---|---|---|---|
| | | Primary | Secondary | Powder | Spray | Robot | Number |
| Current | Voltage | gas, Ar | gas, H2 | feed rate | distance | speed | of |
| (A) | (V) | (I/min) | (I/min) | (g/min) | (cm) | (m/s) | passes |

First Series (fine NiCrAlY powder)

| | | | | | | | | |
|---|---|---|---|---|---|---|---|---|
| Exp 1 (Ref) | 500 | 60 | 43.8 | 6.57 | 64 | 13 | 1 | 10 |
| Exp 2 | 500 | 60 | 43.8 | 6.57 | 32 | 13 | 1 | 20 |
| Exp 3 | 500 | 60 | 43.8 | 6.57 | 64 | 15 | 1 | 10 |
| Exp 4 | 400 | 60 | 43.8 | 6.57 | 64 | 13 | 1 | 10 |

Second Series (coarse NiCrAlY powder)

| | | | | | | | | |
|---|---|---|---|---|---|---|---|---|
| Exp 5 | 400 | 60 | 43.8 | 6.57 | 64 | 13 | 1 | 3 |
| Exp 6 | 400 | 60 | 43.8 | 6.57 | 64 | 13 | 1 | 4 |
| Exp 7 | 400 | 60 | 43.8 | 6.57 | 64 | 13 | 1 | 5 |

### Part 3: Adhesion Strength

In this step, a flatwise tensile test was performed for measuring the adhesion strength (bond strength) of the coated samples. For this purpose, first, a two-component adhesive (Henkel Loctite Hysol EA 9392 AERO Epoxy Adhesive Gray, LOCTITE, Henkel Canada Corporation, Canada) including epoxy and hardener were mixed together with a weight ratio by weight of 100:32. On completion of the mixing, a thin and even layer of the mixture was applied on both sides of the 2.5 by 2.5 cm coated samples. Following this, the samples were sandwiched between two stainless steel blocks and placed in an oven at a temperature of 85° C. and for about 90 minutes for curing the adhesive. Once the curing process was completed, the blocks were connected to two Wyoming flatwise tensile test fixtures by using two pins. The fixtures were then placed in a flatwise tensile machine (with a displacement rate of 0.50 mm/min) for applying tension and measuring the adhesion strength of the coatings. The samples then were analyzed for detecting the failure type.

### Part 4: Electrical Characterization of the Coated Samples

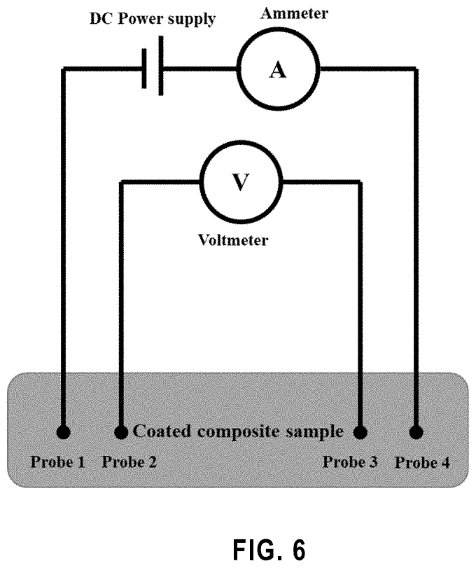

Given that the amount of heat generated by a coated heating element (de-icing element) for a given current depends directly on the coating electrical resistance, the electrical properties of the coating were determined. For this purpose, the four-point electrical probe technique was used for determining the electrical properties of the specimens. This technique is very useful for eliminating the wire and contact resistances that may cause an error in calculating the resistance of the sample. A schematic view of this method is shown in FIG. 6. As can be seen in this figure, for doing the four-point probe test, four wires were attached to the samples top face. A constant current was applied to the sample through probes 1 and 4 connected to a power supply. In addition, an ammeter was installed in series with the circuit and between the power supply and probe 4 for increasing the accuracy of the current measurement. A voltmeter was connected to the sample using probes 2 and 3 for measuring the voltage drop between these two spots. It should also be noted, given that the voltmeter is parallel to the circuit and has a very high resistance, no current passes through the voltmeter, so it has no impact on the amount of current registered on the ammeter.

Different electrical currents (6, 9, and 12 A) were applied to the samples, and the resulted voltage drop between spots 2 and 3 was measured using a voltmeter at the same time. The electrical resistance R and resistivity ρ of the coatings were then calculated as follows:

$$\begin{matrix}R = \frac{V}{I} = \frac{Δ V}{Δ I} & ( 1 ) \\ ρ = R \frac{A}{l} = R \frac{bd}{l} & ( 2 )\end{matrix}$$

Sheet resistance is another electrical term used more for electrical characterization of the relatively thin coatings and paints. By referring to Equation 1, the sheet resistance can be calculated as follows:

$$\begin{matrix}R = ρ \frac{l}{A} = ρ \frac{l}{bd} = \frac{ρ}{d} \frac{l}{b} = {R}_{S} \frac{l}{b} \\ Where & ( 3 ) \\ {R}_{S} = \frac{ρ}{d} & ( 4 )\end{matrix}$$

Rs is the sheet resistance. The sheet resistance is the resistivity of a specimen divided by its thickness and its unit is ohme Ω. For analyzing the performance of the coatings in generating heat and acting as a heating element, the generated power per unit area (intensity) in each coated sample for a given current was calculated by using the following equation:

$$Intensity = \frac{P}{{A}_{S}} = \frac{1}{{A}_{s}} {RI}^{2} \qquad ( 5 )$$

in which Aₛ is the surface area.

### Experiment Results and Discussion

### Part 1: Composite Substrates Preparation

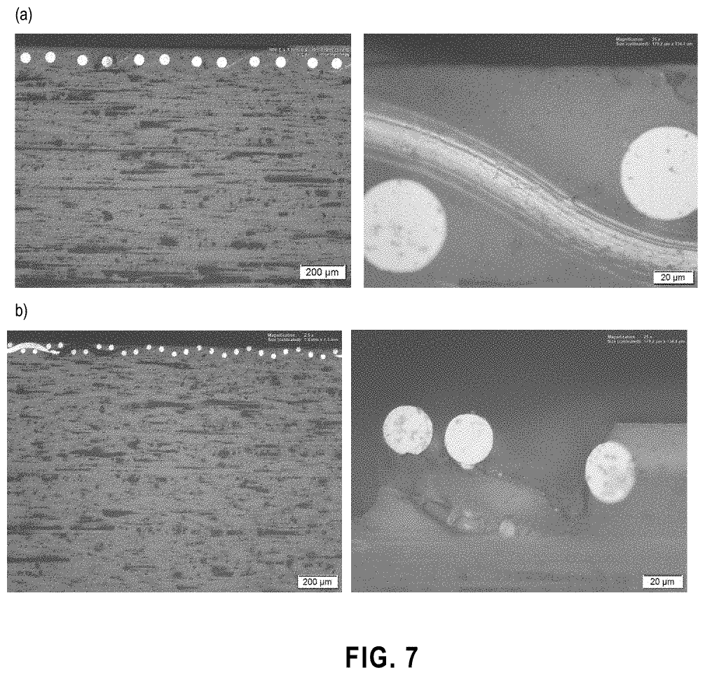

As mentioned, three types of composite substrates were prepared for the deposition of the NiCrAlY coating, which are: conventional composite substrate, 200 mesh substrate, and 400 mesh substrate. Before grit blasting and preparing the substrates for the coating deposition process, the 200 and 400 mesh substrates were characterized and their cross-sections were examined under an optical microscope. FIGS. 7 (a) and (b) shows the low and high magnification microscopic images of 200 and 400 mesh substrates cross-section after fabrication, respectively. In the case of 200 mesh substrate (FIG. 7(a)), it can be seen that the epoxy penetrated perfectly through the steel mesh wires and formed a uniform and thin layer on top of the mesh. In the case of 400 mesh substrate (FIG. 7(b)), the overall resin penetration through the steel mesh is relatively good. However, by going to a higher magnification, it can be seen that the resin penetration in some locations is insufficient. This is possibly because the steel mesh used in the 400 mesh substrate is very fine, and consequently a perfect resin penetration through the steel mesh is very difficult and demands to apply high pressures to the composite plates during the curing process. Therefore, it can be concluded that the steel mesh in the 200 mesh substrate may generally have higher adhesion strength to the underlying composite material layer.

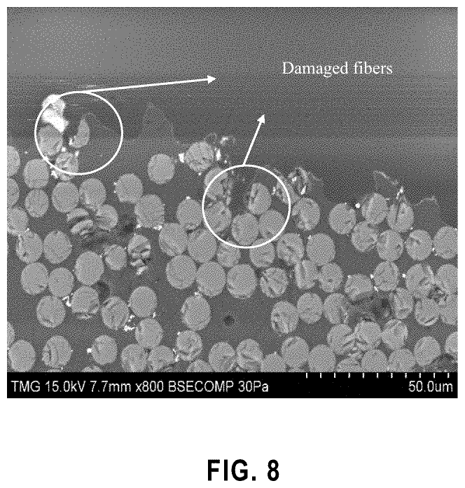

After examination of the cross-section of the composite substrates, the samples were grit-blasted under different grit blasting parameters. FIG. 8 depicts the cross-section of a conventional composite substrate without any metal mesh after grit blasting. From this image, it is obvious that grit blasting induced significant damage to the fibres due to the impact of high-velocity abrasive particles. Presence of the metal mesh can protect the fibres and at the same time act as an anchor to keep the coating on the surface. Proper preparation of the polymeric samples prior to the coating deposition may affect the fabrication of a uniform coating with high-quality.

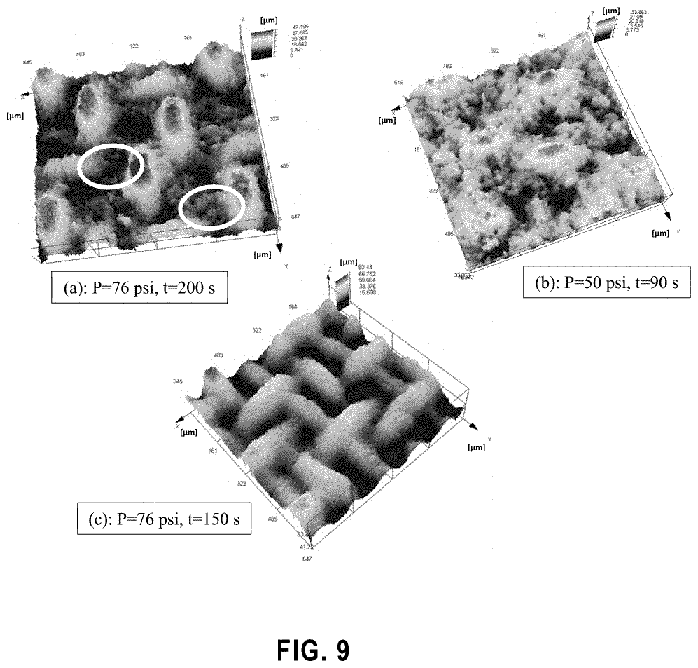

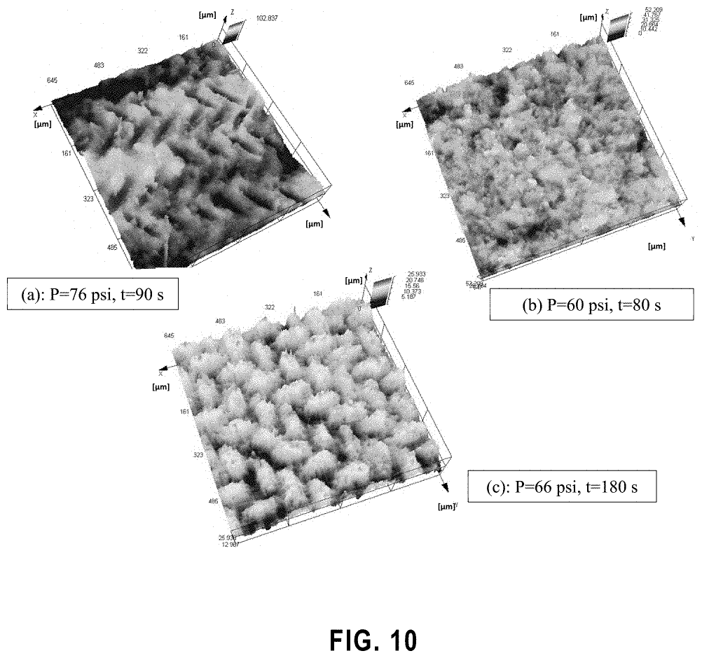

As mentioned earlier, more than 30 composite substrates (200 and 400 mesh substrates) were grit-blasted to obtain an optimized set of grit blasting parameter for each type of substrate. FIG. 9 shows the confocal images of the top surface of three 200 mesh substrates grit-blasted with different parameters. In the first case, in which the substrate was grit-blasted with an air pressure of 76 psi for 200 s, it can be seen that some steel wires were removed or damaged. In the second case, the substrate was grit-blasted with a pressure of 50 psi for 90 s. In this sample, unlike the previous case, no damage is induced to the steel wires. However, in this case, a high percentage of the wires is still covered with epoxy, and this may have a negative impact on coating adhesion and deposition efficiency in the next steps (see below) due to the fact that the more steel wires there are on the substrate surface, the better the coating adhesion may be. Finally, the last case shows a 200 mesh substrate grit-blasted with the optimized parameters (P=76 psi and t=150 s). In this sample, the steel wires are in good condition and comprise a high percentage of the composite surface, while they also have a good anchorage and bonding with the composite part. In fact, using these optimized grit blasting parameters resulted in removing about 50% of the epoxy exist on top of the steel wires. FIG. 10 illustrates the grit-blasted 400 mesh substrates. From this figure, it is clear that the optimized case was achieved (due to the same reasons as for grit blasting the 200 mesh substrates) by grit blasting the 400 mesh substrate with an air pressure of 66 psi for 180 s.

Globally, by comparing FIG. 9 and FIG. 10, it can be found that optimizing the grit blasting parameters can improve the roughening of the substrate surface. The 200 mesh substrates are less sensitive and vulnerable to the grit blasting parameters as their cloth steel wires are thicker and more resistant to the impact of high-velocity particles and better results were obtained when compared to the 400 mesh substrates. Furthermore, as the metallic mesh holes' dimensions were smaller than the grit blasting sand diameter, the sand likely could not penetrate to the composite part of the substrates and break the fibers during grit blasting. By measuring the surface roughness, it was also found that the 400 mesh substrate grit-blasted with the optimized parameters has a surface roughness of about 7 μm, while this value for the 200 mesh grit-blasted with the optimized parameters is about 11 μm (about 50% higher compared to the grit-blasted 400 mesh substrate). This might be due to the relatively large voids existing on the 200 mesh substrate surface. So, it is expected that using this kind of substrate may result in a better coating deposition and adhesion during spraying.

### Part 2: Coating of the Composite Substrates

Four experiments (see Table 3 above) were performed to find an appropriate set of spray parameters for depositing a NiCrAlY coating layer onto composite substrates. In this series of experiments, the NiCrAlY powder with fine size distribution (−37+11 μm) was used as the coating material. In experiment 1, samples were coated using the reference parameters. As shown in FIG. 11, in this experiment, all the composite samples were burnt, and in the cases of 200 and 400 mesh substrates, in addition to the burning, the steel cloth and coating were peeled off from the composite part of the substrate. These results might be explained by the fact that the temperature of the substrate during coating deposition (about 200° C.) exceeded the material limits. Consequently, the bonding between the steel wire and the composite part got loose and the steel mesh cloth started debonding from the substrate.

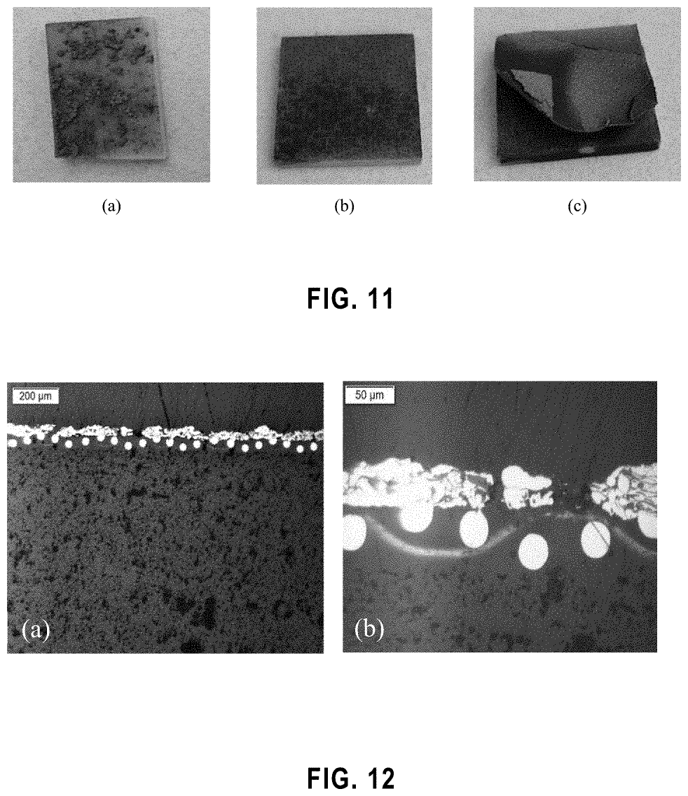

In experiment 2, in which the powder feed rate was decreased from 64 to 30 g/min (compared to experiment 1), the samples were not burnt. However, as shown in FIG. 12, the coating deposition efficiency was low. The maximum surface temperature of the substrates in this experiment was about 110 G. In experiment 3, in which the standoff distance was increased from 13 cm to 15 cm (compared to experiment 2), the deposition was also low. In addition, partial burnings were observed in all the composite samples. The maximum surface temperature of the substrates during spraying was about 165° C.

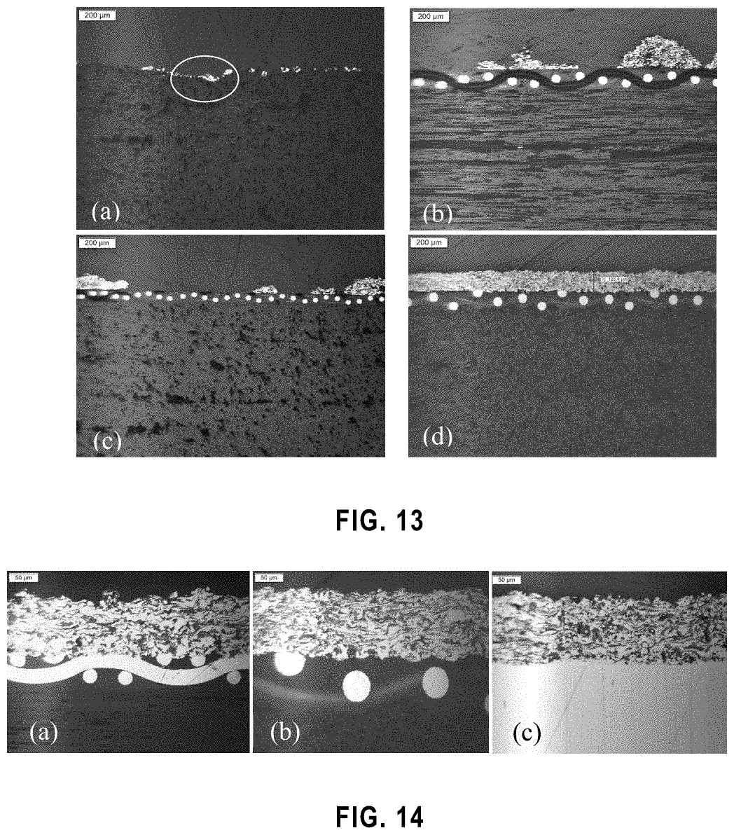

In experiment 4, the plasma current was reduced from 500 A to 400 A. Consequently, the plasma input power decreased about 25% compared to the previous experiments. The maximum surface temperature of the substrates during spraying was about 105° C. FIG. 13 depicts the cross-section of the samples coated using experiment 4 spray parameters with low magnification. It can be seen that in the case of the conventional composite substrate (FIG. 13a), the coating deposition and adhesion is very low. Furthermore, it is clear that the composite surface is non-uniform, and a lot of composite fibers were removed from the top of the substrate due to the grit blasting done before the spraying process. As shown in FIG. 13b, in the case of not grit-blasted 200 mesh substrate, the coating deposition is better than the previous, but still limited and non-uniform. In a not grit-blasted 200 mesh substrate, the steel wires are covered with a thin epoxy layer. So, when the molten NiCrAlY particles (during spraying) reach to the substrate, they face with an epoxy layer instead of metallic wires. That is likely why the coating deposition, in this case, is limited. In addition, since this sample was not grit-blasted before the coating deposition process, there was no rough surface for the molten particles to lock into and fully adhere. From FIGS. 13c and d, it is apparent that grit blasting the 200 and 400 mesh substrates have made a considerable improvement in the coating adhesion and deposition efficiency. Indeed, in these substrates, the steel mesh protected the composite part, especially the fibers, from the impact of high-velocity particles during grit blasting and spraying. In addition, as the steel wires comprised a high percentage of the surface of 200 and 400 mesh substrates, the NiCrAlY coating was deposited with high uniformity and efficiency. In addition, the holes created by grit blasting between the steel wires may have an influence on improving the anchorage of the molten particles to the substrate surface and consequently on improving the coating adhesion.

FIG. 14 shows the coated 200 and 400 mesh substrates with higher magnification, and a coated stainless steel block. It is clear that in these three samples, the coatings are very similar to each other from uniformity, thickness, and quality points of view. This shows that the addition of steel mesh cloths to the composite substrates has improved the coating deposition efficiency up to a grit-blasted stainless steel block. The average coating thickness in this experiment was about 94±2.3 μm.

In the second phase of experiments (experiments 5-7), composite substrates were coated using the coarse NiCrAlY powder with a size distribution of −74+45 μm, which allowed for a comparison to be made between the coatings sprayed using the coarse powder and those sprayed using the fine powder. This comparison mainly includes analyzing the coatings microstructure, thickness, amount of oxidation, and electrical resistivity to determine which type of coating might be more proper as a heating element. It was found that experiment 4 spray parameters are also suitable and proper for the deposition of coating using coarse NiCrAlY powder. The coating thickness was changing significantly with the number of passes and the deposition efficiency was higher. The composites were coated with the different number of passes (i.e. 3, 4, and 5 passes).

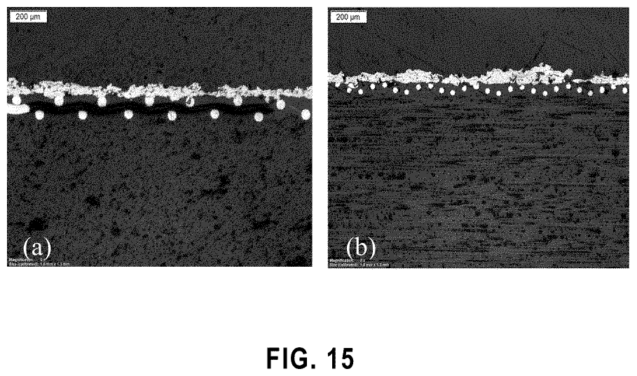

In experiment 5, samples were coated in three passes. As shown in FIG. 15, in both the grit-blasted 200 and 400 mesh substrates, the coating is not uniform. The generated coatings had an average thickness of 39.0±3.1 μm. The maximum surface temperature of the substrates during spraying was about 109° C.

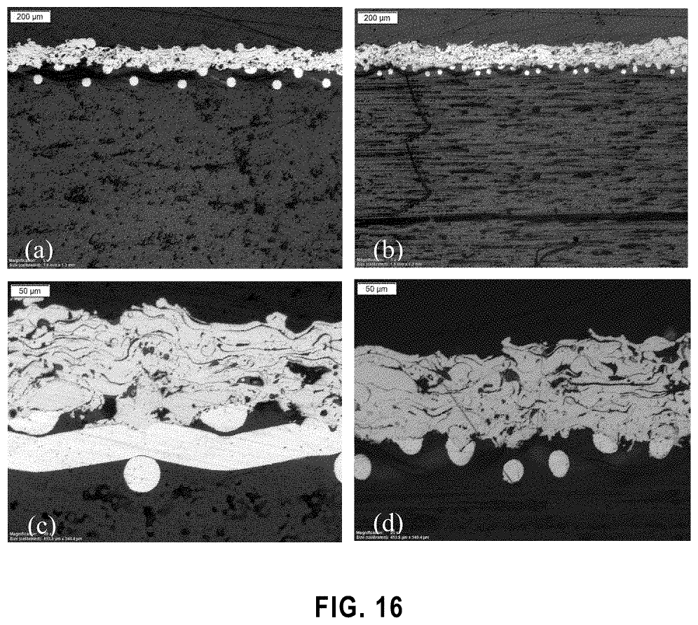

In experiment 6, in which the composite samples were coated in 4 passes, the coatings had a relatively uniform thickness (see FIG. 16). The average thickness of the deposited coatings was about 83.5±4.2 μm. By comparing FIG. 14 and FIG. 16, it can be found that the NiCrAlY coating deposited using coarse NiCrAlY powder has a higher porosity and lower degree of oxidation in comparison to the one deposited using fine NiCrAlY powder. The higher porosity could be attributed to the fact that in the plasma plume, coarse particles have relatively lower melting efficiencies and lower speed than fine particles which result in larger amounts of unmolten particles and the formation of big pores between coating splats. In addition, the total surface area of the fine particles (sum of the surface area of all particles) sprayed in a period of time is considerably greater than that of the coarse particles which contributes to more heat absorption, and consequently more oxidation when the fine powder is used for the coating deposition. The maximum surface temperature of the substrates in this experiment also was about 118° C.

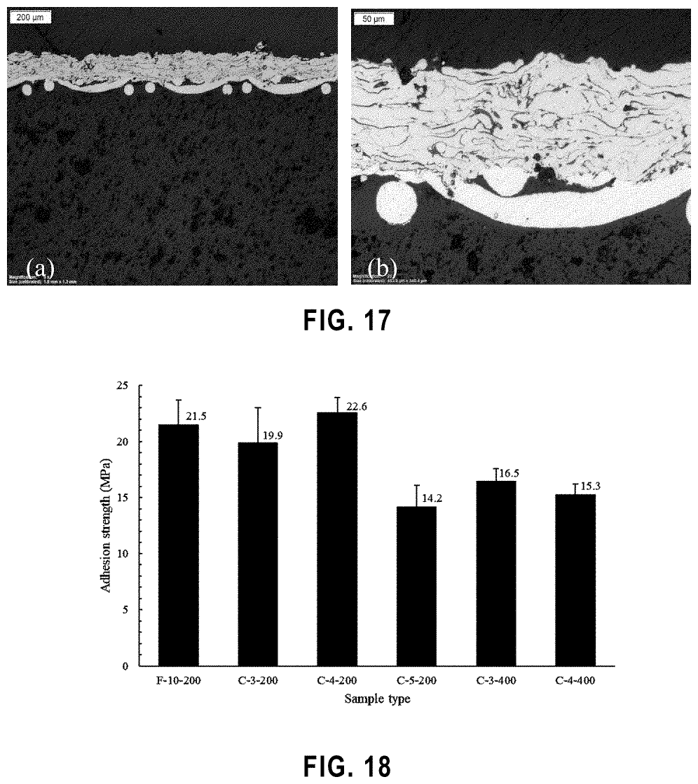

Finally, in experiment 7, the coatings were sprayed onto the composite substrates in 5 passes. As shown in FIG. 17, the coating was deposited on the top of the grit-blasted 200 mesh substrate utterly and without inducing any damage to the composite part. However, when the grit-blasted 400 mesh was used as a substrate, the coated steel mesh cloth started peeling off during the fifth pass. This peeling off was likely due to the imperfect bonding of the steel mesh cloth to the composite part, the weak and thin steel wires, as well as the residual stresses induced to the substrate by increasing the number of passes and coating thickness. The coatings deposited in this experiment had an average thickness of 96±4.0 μm. The substrates had a maximum surface temperature of about 135° C.

Overall, the results of these seven experiments show that an appropriate and uniform NiCrAlY coating layer could be deposited onto the grit-blasted 200 and 400 mesh substrates by using both fine and coarse NiCrAlY powders. It can also be seen that using the powder with the fine size distribution resulted in the formation of a coating with higher uniformity as the powder particles were significantly smaller compared to those of the coarse powder. The image analysis results also show that in the coatings generated using fine powder, the porosity is very low (0.9±0.1%), and the oxidation is relatively high (31.6±1.6%). On the contrary, in the coating generated by the coarse powder, the porosity is relatively high (6.4±1.2%), and the oxidation is relatively low (11.8±1.4%). It also seems that utilizing the coarse powder contributes to a better deposition efficiency as a 100 μm NiCrAlY coating layer can be fabricated in 5 passes using the coarse powder and in 10 passes using the fine powder while the powder feed rate in both cases is 65 g/min. However, it should be noted that controlling the coating thickness in the case of using fine powder tends to be considerably better and easier. Another interesting observation is that the coating tends to penetrate more into the mesh cloth and substrate when it is sprayed using the coarse powder. This might be explained by the fact that the coarse powder particles are notably heavier than the fine powder particles, and consequently, when they reach the substrate, they have more momentum and penetrate more into the steel mesh cloth. It should also be noted that in all cases, the coatings did not reach and damage the composite fibers.

### Part 3: Adhesion Strength

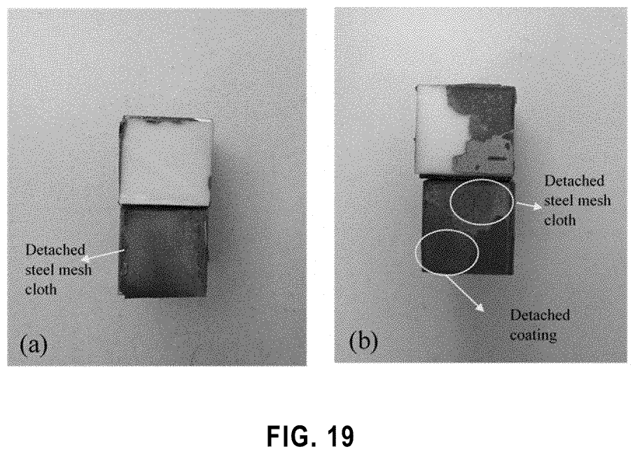

In order to quantify the adhesion between the substrate and coating, a flatwise tensile test (defined above) was performed. The bonding strength results of the NiCrAlY coatings deposited onto the composite substrate are depicted in FIG. 18. In this figure, the code used to identify the samples consists of three parts. The first part specifies the type of coating material and F stands for the fine powder and C stands for the coarse powder. The second part stands for the number of passes in which the coating was deposited in and the third part specifies the type of composite substrate, 200 stands for the 200 mesh substrate and 400 stands for 400 mesh substrate. The adhesion strength test was repeated 3 times for each coated sample. As shown in FIG. 18, samples C-4-200 and F-10-200 have the highest coating adhesion strength. Another interesting observation is that globally the samples in which 200 mesh composites were used as the substrate (except C-5-200) have a higher adhesion strength compared to the samples in which 400 mesh composites were used as the substrate. In all coated 400 mesh substrates (C-3-400 and C-4-400), the failure occurred at the interface of the steel mesh cloth and the composite part (see FIG. 19). This is likely due to the imperfect bonding of the 400 mesh cloth to the composite part. The maximum adhesion strength in the case of a coated 400 mesh substrate is around 15 MPa. On the other hand, as shown in FIG. 19, the failure mode in the cases in which 200 mesh composites were used as the substrate, is a combination of coating failure and mesh cloth failure. The lowest bonding strength was achieved for sample C-5-200. This observed decrease in the adhesion strength could be attributed to the significant stresses that were induced to the substrate due to increasing the number of passes and coating thickness as well as being in the exposure of hot gas temperatures for a longer amount of time. The adhesion strength values obtained for samples C-4-200 and F-10-200 are about 50% higher than the adhesion strength values reported for the coated composites in the literature.

### Part 4: Electrical Characterization

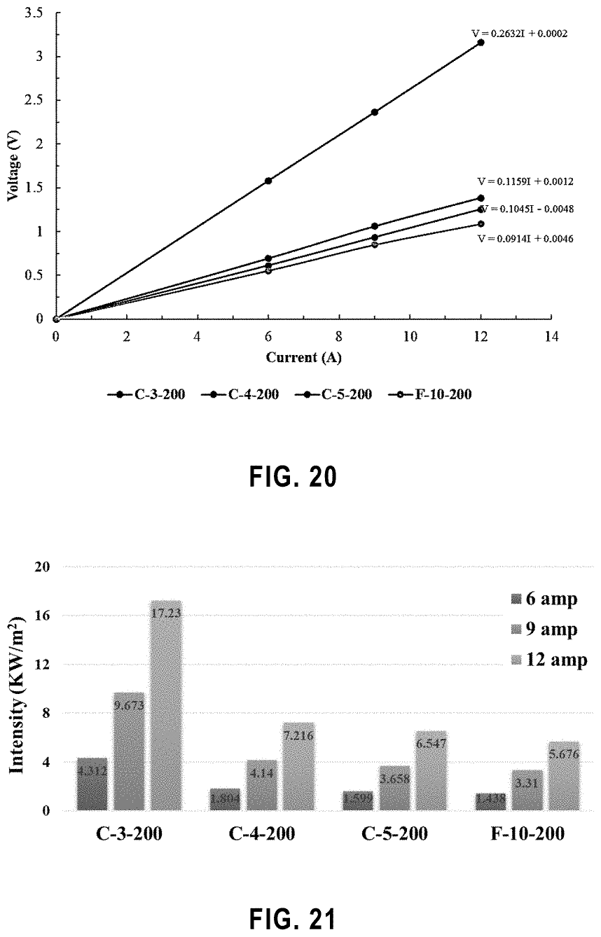

The coated samples were characterized electrically using the four-point probe method (defined above). Currents of 6, 9, 12 A were applied to the coated samples and the resulted voltage was measured. The relationship between the applied currents through the coating and the corresponding voltage for the coated samples with the dimensions of 2.3-by-10 cm is shown in FIG. 20. As expected, in all cases, the voltage has a linear relationship with the current. This shows that all the coated samples obey Ohm's law. Given that

$$R = \frac{V}{I} = \frac{Δ V}{Δ I} ,$$

V-I curves' slope represents the electrical resistance of the coatings. So, the electrical resistance of samples F-10-200, C-5-200, C-4-200, and C-3-200 are 0.091, 0.104, 0.116, and 0.263Ω, respectively. The resistance of the coated samples was also measured at different temperatures (25 to 150° C.). It was found that in that range of temperature, in all the cases, the resistance of the NiCrAlY coating is almost constant and independent of the coating surface temperature. This is one of the advantages of NiCrAlY over other materials used for the fabrication of heating element coatings (e.g. NiCr, FeCrAl). From FIG. 20, it is apparent that sample C-3-200 has the highest resistance value. In fact, as

$$R = ρ \frac{l}{A} = ρ \frac{l}{bd} ,$$

the resistance is directly proportional to the electrical resistivity and length and is inversely proportional to the cross-section area. By increasing the number of passes and consequently the coating thickness, the resistance tends to decrease. In addition, by comparing samples C-5-200 and F-10-200 it can be seen that the resistance of the former is a little bit higher, while in both cases, the coating thickness is approximately the same. This is due to the fact that the electrical resistivity of the coatings generated by the coarse powder is about 12% higher than that of the coatings generated by the fine powder (see Table 4 below). By having the resistance of the coatings, the resistivity could be calculated. Resistivity is an intrinsic property that unlike resistance does not depend on the shape and dimensions of the material. So, the resistivity value of two coatings sprayed with the same spray parameters but with a different number of passes should be similar and close to each other. However, as the spray parameter and powder size have a direct impact on the percentage of coating oxidation and porosity, changing them may slightly result in different resistivity values. In addition, since the coatings are always associated with porosity and oxidation, their intrinsic properties like electrical resistivity are usually different from the bulk and pure materials. As mentioned earlier, the image analysis showed that the coatings generated using fine powder have a porosity of 0.9±0.1% and an oxidation of 31.6±1.6%, and the coatings generated using coarse powder have a porosity of 6.4±1.2% and an oxidation of 11.8±1.4%. By comparing the resistivity values of the coatings, it seems that the porosity had a more important role and impact, compared to the oxidation, in increasing the coating resistivity value.

Sheet resistance, which is an electrical term used more for characterizing thin coatings, was calculated using

$${R}_{S} = \frac{ρ}{d} = R \frac{b}{l} .$$

The sheet resistance values for different types of coatings are shown in Table 4 below. One advantage of sheet resistance over electrical resistance is its independence from the size which makes a comparison between different samples easier. It also shows the capability of a sample in generating heat when a given current is applied to it. The sheet resistance of sample C-3-200 (about 0.058 Ω/square) is noticeably higher than that of the other coated samples due to its lower thickness. This means that this type of coating should generate more power and heat compared to the other coated samples for a given current. The sheet resistance values of the other coated samples are relatively close to each other as there is not a very big difference between their thicknesses and resistivity values.

TABLE 4
Electrical properties of the coated samples.

| Sample | Average ρ | Average sheet |
|---|---|---|
| type | (μΩ.m) | resistance (Ω/square) |
| C-3-200 | 2.264 ± 0.179 | 0.0580 ± 0.0100 |
| C-4-200 | 2.170 ± 0.109 | 0.0268 ± 0.0021 |
| C-5-200 | 2.295 ± 0.095 | 0.0239 ± 0.0020 |
| F-10-200 | 1.993 ± 0.048 | 0.0212 ± 0.0020 |

### Part 5: Performance of the Coated Samples as a Heating Element

Once the samples were characterized electrically, their performance in generating power and acting as a heating element was tested. For this purpose, the generated intensity (power per unit area) of the coated composite samples for a given current was calculated using

$$Intensity = \frac{P}{{A}_{S}} = \frac{1}{{A}_{s}} {RI}^{2}$$

equation. The amount of generated intensity in the coated samples for 6, 9, and 12 A currents is presented in FIG. 21. The intensity goes up significantly by increasing the current as it is directly proportional to the square of the current value. It is apparent that sample C-3-200 has the highest capability in generating heat due to its considerably higher resistance value compared to the other samples. Based on the literature, the amount of intensity needed to be provided by the heating elements for de-icing purposes is in the range of 2.1-3.6 kW/m².

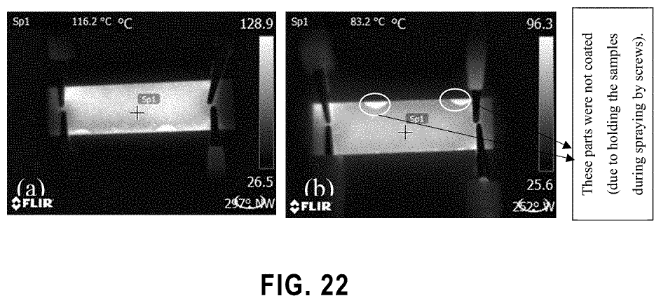

The infrared camera pictures (see FIG. 22) show that in cases in which the coating thickness is not uniform, like sample C-3-200, the surface temperature distribution of the coating (while it is connected to a power source) is also non-uniform, while in the other cases (samples F-10-200, C-4-200, and C-5-200) in which the coating is uniform, the surface temperature distribution also has a high uniformity. In fact, when a coating is not uniform, the electrical resistance changes along the coating and this consequently tends to result in the generation of different amounts of power along the surface coating. That is likely why such a coating does not have a uniform surface temperature. Based on several factors, like the intended application of heating element, where it is intended to be used, the amount of power needed, the importance of uniformity, and other limitations, each of these heating element coatings might be useful.

### CONCLUSION

In these experiments, a method for the fabrication of a NiCrAlY coating layer on polymer-based composite materials by using a plasma spray technique is tested. Three types of composite substrates were made by using glass fibre reinforced prepreg plies and stainless steel mesh cloths, which were: 1) a conventional composite substrate, 2) a 200 mesh substrate, which was made by incorporating an extra 200 stainless steel mesh cloth on top of the prepregs, and 3) a 400 mesh substrate which was made by incorporating an extra 400 stainless steel mesh cloth on top of the prepregs. After preparing the composite substrates by grit blasting, the samples were coated by fine and coarse NiCrAlY powders. The microscopic images of the coated sample cross-sections revealed that the deposition of a metallic coating onto conventional composites is very limited. In this case, the grit blasting also resulted in breaking and damaging the composite fibers significantly. However, in the cases of 200 and 400 mesh substrates, it was observed that a uniform NiCrAlY coating with high deposition efficiency and uniformity could be deposited by using a proper set of spray parameters. Indeed, the incorporation of the stainless steel mesh cloths to the composite structure not only improved the coating adhesion and deposition efficiency significantly but also played the role of armor for the composite part and protected the composite fibers from the impact of high-velocity particles during grit blasting and spraying. It was also observed that using the fine NiCrAlY powder resulted in the generation of coatings with very high uniformity. Also, the coatings that were deposited in 4 and 5 passes using the coarse powder had adequate uniformity. However, the controllability in the case of using coarse powder was relatively low as the coating thickness was changing significantly with the number of passes. The deposition efficiency of the coarse powder also was higher than the fine powder. The results of the coating adhesion strength showed that the coating bonding strength in the cases in which the 200 mesh composite was used as the substrate is very high. The adhesion strength values obtained for samples C-4-200 and F-10-200 (about 22 MPa) were about 50% higher than the adhesion strength values reported for the coated composites in the literature.

The results of the electrical characterization of the coated samples also indicated that using NiCrAlY powder with the coarse size distribution (compared to the fine powder) tends to result in the formation of coatings with higher resistivity value. After checking the performance of the coated samples as a heating element, it was found that all the coated samples have the capability of generating intensity more than the amount of intensity required for de-icing applications. Sample C-3-200 had the highest capability in generating power for a given current; however, in this case, unlike other samples (F-10-200, C-4-200, and C-5-200), the surface temperature distribution was non-uniform. Based on several factors, like the intended application of heating element, where it is intended to be used, the amount of power needed, the importance of uniformity, and other limitations, each of these heating element coatings might be useful. It is worth noting that the 200 steel mesh cloth used in this study just adds 0.28 kg/m² to the weight of the substrate, while the equipment used in conventional de-icing systems (like bleed air de-icing systems) adds hundreds of pounds of weight to the aircraft.

The scope of the claims should not be limited by the preferred embodiments set forth in the examples, but should be given the broadest interpretation consistent with the description as a whole.

### REFERENCES

The present description refers to a number of documents, the content of which is herein incorporated by reference in their entirety. These documents include, but are not limited to, the following:
“787 NO-BLEED SYSTEMS.” https://www.boeing.com/commercial/aeromagazine/articles/qtr_4_07/article_02_1.html (accessed Sep. 10, 2019).
P. L. Fauchais, J. V. Heberlein, and M. I. Boulos, Thermal spray fundamentals: from powder to part. Springer Science & Business Media, 2014.
J. R. Davis, Handbook of thermal spray technology. ASM international, 2004.
L. Pawlowski, The science and engineering of thermal spray coatings. John Wiley & Sons, 2008.
A. Liu, M. Guo, M. Zhao, H. Ma, and S. Hu, “Arc sprayed erosion-resistant coating for carbon fiber reinforced polymer matrix composite substrates,” Surface and Coatings Technology, vol. 200, no. 9, pp. 3073-3077, 2006.
A. Ganesan, M. Yamada, and M. Fukumoto, “The effect of CFRP surface treatment on the splat morphology and coating adhesion strength,” Journal of Thermal Spray Technology, vol. 23, no. 1-2, pp. 236-244, 2014.
R. Lima et al., “Temperature Measurements of Polymer Composite Flat Plates Coated with Aluminum-12Silicon,” 2012.
R. Gonzalez, A. McDonald, and P. Mertiny, “Effect of flame-sprayed Al-125i coatings on the failure behaviour of pressurized fibre-reinforced composite tubes,” Polymer Testing, vol. 32, no. 8, pp. 1522-1528, 2013.
D. S. Therrien, “Heat Transfer Analysis of Flame-sprayed Metal-polymer Composite Structures,” 2013.
H. Ashrafizadeh, A. McDonald, and P. Mertiny, “Deposition of electrically conductive coatings on castable polyurethane elastomers by the flame spraying process,” Journal of Thermal Spray Technology, vol. 25, no. 3, pp. 419-430, 2016.
A. Ganesan, M. Yamada, and M. Fukumoto, “Cold spray coating deposition mechanism on the thermoplastic and thermosetting polymer substrates,” Journal of Thermal Spray Technology, vol. 22, no. 8, pp. 1275-1282, 2013.
A. Sturgeon, B. Dunn, S. Celotto, and W. O'Neill, “Cold sprayed coatings for polymer composite substrate,” ESA SP, vol. 616, no. 1, pp. 1-5, 2006.
R. Gonzalez, A. McDonald, and P. Mertiny, “Damage detection method for fiber-reinforced polymer composites using Al-125i flame-sprayed coatings,” in Society of Advancement of Material and Process Engineering (SAMPE) 2014 Conference, 2014, pp. 2-5.
A. Lopera-Valle and A. McDonald, “Application of flame-sprayed coatings as heating elements for polymer-based composite structures,” Journal of Thermal Spray Technology, vol. 24, no. 7, pp. 1289-1301, 2015.
A. Lopera-Valle and A. McDonald, “Flame-sprayed coatings as de-icing elements for fiber-reinforced polymer composite structures: Modeling and experimentation,” International Journal of Heat and Mass Transfer, vol. 97, pp. 56-65, 2016.
G. Sun, X. He, J. Jiang, Y. Sun, and Y. Zhong, “A study on the deposition of Al 2 O 3 coatings on polymer substrates by a plasma spray/micro-arc oxidation two-step method,” Journal of Thermal Spray Technology, vol. 22, no. 1, pp. 27-35, 2013.
W. Huang et al., “Effect of bond coats on thermal shock resistance of thermal barrier coatings deposited onto polymer matrix composites via air plasma spray process,” Journal of Thermal Spray Technology, vol. 22, no. 6, pp. 918-925, 2013.
A. Liu, M. Guo, J. Gao, and M. Zhao, “Influence of bond coat on shear adhesion strength of erosion and thermal resistant coating for carbon fiber reinforced thermosetting polyimide,” Surface and Coatings Technology, vol. 201, no. 6, pp. 2696-2700, 2006.
W. Huang et al., “Fabrication of thermal barrier coatings onto polyimide matrix composites via air plasma spray process,” Surface and Coatings Technology, vol. 207, pp. 421-429, 2012.
S. Guanhong, H. Xiaodong, J. Jiuxing, and S. Yue, “Parametric study of Al and Al₂O₃ ceramic coatings deposited by air plasma spray onto polymer substrate,” Applied Surface Science, vol. 257, no. 17, pp. 7864-7870, 2011.
J. Affi, H. Okazaki, M. Yamada, and M. Fukumoto, “Fabrication of aluminum coating onto CFRP substrate by cold spray,” Materials Transactions, pp. 1108081451-1108081451, 2011.
D. Seo and K. Ogawa, “Isothermal oxidation behavior of plasma sprayed MCrAlY coatings,” Advanced Plasma Spray Applications, pp. 61-82, 2012.
A. Shinkafi, C. Lawson, R. Seresinhe, D. Quaglia, and I. Madani, “An Intelligent Ice Protection System for Next Generation Aircraft Trajectory Optimisation,” St. Petersburgh, Russia, 2014.
J. Sloan, “787 integrates new composite wing deicing system,” High Performance Composites, vol. 17, no. 1, pp. 27-29, 2009.
O. Meier and D. Scholz, “A handbook method for the estimation of power requirements for electrical de-icing systems,” DLRK, Hamburg, vol. 31, 2010.

1. A composite substrate comprising a mesh layer and a composite material layer, wherein the mesh layer comprises a mesh material and an adhesive, said adhesive permeating the mesh material and adhering the mesh material directly to a surface of the composite material layer.

2. The composite substrate of claim 1, wherein the composite material layer comprises at least one polymeric composite material, the polymeric composite material comprising reinforcing fibers embedded in a polymer matrix.

3.-9. (canceled)

10. The composite substrate of claim 1, wherein the mesh material is made of metal.

11.-13. (canceled)

14. The composite substrate of claim 1, wherein the mesh size is at least about 50 and at most about 700.

15. (canceled)

16. The composite substrate of claim 1, wherein the mesh is completely embedded in the adhesive, such that none of the mesh material is exposed to the environment.

17. (canceled)

18. The composite substrate of claim 1, wherein the mesh material is at least partially exposed to the environment.

19. (canceled)

20. The composite substrate of claim 1, further comprising a metal layer covering a side of the mesh layer opposite the composite layer.

21. (canceled)

22. The metal-coated composite substrate of claim 20, wherein the surface roughness of the surface of the mesh layer opposite the composite layer before the metal is deposited thereon is between about 4 μm and about 15 μm.

23.-27. (canceled)

28. The metal-coated composite substrate of claim 20, wherein the uniformity of the thickness of the metal layer is between about ±1% and about ±10.

29.-38. (canceled)

39. The metal-coated composite substrate of claim 20, wherein the degree of porosity of the metal layer is between about 0.5% and about 40%.

40.-47. (canceled)

48. A method for producing the composite substrate of claim 1, comprising the step of adhering a mesh material to a surface of a composite material layer using an adhesive, said adhesive at least partially permeating the mesh material, thereby adhering the mesh material to the composite material layer, and thereby producing the composite substrate.

49. The method according to claim 48, wherein a preexisting coating is removed to expose a surface of the composite material layer prior to the adhering step, after which the mesh layer is adhered directly to said surface of the composite material layer.

50. (canceled)

51. The method according to claim 48, wherein enough adhesive is used during the adhering step such that the mesh material is completely embedded in the adhesive and none of the mesh material is exposed to the environment.

52. The method according to claim 48, wherein a roughing step is performed on a surface of the mesh material opposite the composite material layer prior to the adhering step.

53.-54. (canceled)

55. The method according to claim 48 further comprising the step of depositing a metal layer onto the mesh layer of the composite substrate.

56.-57. (canceled)

58. The method according to claim 55, wherein the depositing step is performed using thermal spray techniques.

59. The method according to claim 58, wherein, during thermal spraying, the particles are cooled down to keep the substrates' surface temperature as low as possible during spraying.

60. (canceled)

61. The method according to claim 55, wherein, before the metal layer is deposited onto the mesh layer of the composite substrate, the mesh layer is roughened.

62. The method according to claim 48, wherein the composite material layer is provided from an existing part or structure.

63.-64. (canceled)

65. Method of using the metal-coated composite of claim 1 as an electro-thermal heating element, the method comprising passing a current through the metal layer so as to generate heat in the metal layer.
